(19) United States
(12) Patent Application Publication
(10) Pub. No.: US 2009/0292870 A1
(43) Pub. Date: Nov. 26, 2009

(54) STORAGE APPARATUS AND CONTROL METHOD THEREOF

(76) Inventors: Eiji SAMBE, Odawara (JP); Noboru Furuumi, Yokohama (JP); Kunihiko Nashimoto, Odawara (JP)

Correspondence Address: MATTINGLY & MALUR, P.C., 1800 DIAGONAL ROAD, SUITE 370, ALEXANDRIA, VA, 22314, US

(21) Appl. No.: 12/169,792

(22) Filed: Jul. 9, 2008

(30) Foreign Application Priority Data
May 23, 2008 (JP) 2008-134939

(51) Int. Cl. G06F 12/02; G06F 12/06; G06F 12/08

(52) U.S. Cl. 711/114; 711/170; 711/E12.002; 711/E12.016; 711/E12.084

(57) ABSTRACT

With this storage apparatus and its control method for presenting multiple virtual volumes to a host apparatus and dynamically allocating to each of the multiple virtual volumes a physical storage area for storing data according to the usage status of each of the multiple virtual volumes, the importance set to each of the multiple virtual volumes is managed, and a storage area is dynamically allocated to each of the multiple virtual volumes. Here, upon dynamically allocating the storage area to each of the multiple virtual volumes, a storage area provided by a plurality of memory apparatus groups respectively configured from a plurality of memory apparatuses is allocated to one or more virtual volumes with low importance among the multiple virtual volumes, and a storage area provided by one of the memory apparatus groups is allocated to other virtual volumes among the multiple virtual volumes.

### CROSS-REFERENCES

This application relates to and claims priority from Japanese Patent Application No. 2008-134939, filed on May 23, 2008, the entire disclosure of which is incorporated herein by reference.

### BACKGROUND

The present invention generally relates to a storage apparatus and its control method, and for instance can be suitably applied to a storage apparatus loaded with an AOU (Allocation On Use) function.

In recent years, a SAN (Storage Area Network) environment that uses a SAN to connect a plurality of storage apparatuses to one or more host computers has been put into practical application. Further, there is technology of managing a plurality of storage apparatuses available to one or more host computers as though they are a single common storage apparatus by virtually consolidating a plurality of storage apparatuses under the SAN environment.

Japanese Patent Laid-Open Publication No. 2005-275526 discloses a storage area allocation method of allocating an appropriate storage area to a host computer in a SAN environment to which a plurality of storage apparatuses are connected based on performance/reliability information and location information assigned to the storage areas provided by the respective storage apparatuses,

Japanese Patent Laid-Open Publication No. 2007-280319 discloses virtualization technology referred to as AOU of presenting a virtual volume (hereinafter referred to as a “virtual volume”) as a volume for reading and writing data from and into a host apparatus, and dynamically allocating a physical storage area for actually storing data to the virtual volume according to the usage status of the virtual volume.

### SUMMARY

Meanwhile, with conventional AOU technology, if a failure occurs in one of the parity groups in the memory apparatus, data stored in a storage area in that parity group will be lost.

In this case, with conventional AOU technology, since a storage area provided by a plurality of parity groups is allocated to one virtual volume, a failure in a single parity group will induce data loss in a plurality of virtual volumes. In other words, numerous virtual volumes in an “incomplete” status will arise.

The present invention was made in view of the foregoing points. Thus, an object of the present invention is to propose a storage apparatus and its control method capable of improving the maintainability of important data.

In order to achieve the foregoing object, the present invention provides a storage apparatus for presenting a plurality of virtual volumes to a host apparatus, and dynamically allocating to each of the plurality of virtual volumes a physical storage area for storing data according to the usage status of each of the plurality of virtual volumes. This storage apparatus comprises a management unit for managing the importance set to each of the plurality of virtual volumes, and a storage area allocation unit for dynamically allocating a storage area to each of the plurality of virtual volumes. The storage area allocation unit allocates, based on the importance, a storage area provided by a plurality of memory apparatus groups respectively configured from a plurality of memory apparatuses to one or more virtual volumes with low importance among the plurality of virtual volumes, and allocates a storage area provided by one of the memory apparatus groups to other virtual volumes among the plurality of virtual volumes.

Consequently, with the storage apparatus according to the present invention, virtual volumes other than the low importance virtual volumes are not easily affected by the generation of a failure in the memory apparatus group, and it is thereby possible to reduce the probability of loss of data stored in virtual volumes other than the virtual volumes with low importance.

The present invention additionally provides a control method of a storage apparatus for presenting a plurality of virtual volumes to a host apparatus, and dynamically allocating to each of the plurality of virtual volumes a physical storage area for storing data according to the usage status of each of the plurality of virtual volumes. This control method of a storage apparatus comprises a first step of managing the importance set to each of the plurality of virtual volumes, and a second step of dynamically allocating a storage area to each of the plurality of virtual volumes. At the second step, based on the importance, a storage area provided by a plurality of memory apparatus groups respectively configured from a plurality of memory apparatuses is allocated to one or more virtual volumes with low importance among the plurality of virtual volumes, and a storage area provided by one of the memory apparatus groups is allocated to other virtual volumes among the plurality of virtual volumes.

Consequently, with the control method of a storage apparatus according to the present invention, virtual volumes other than the low importance virtual volumes are not easily affected by the generation of a failure in the memory apparatus group, and it is thereby possible to reduce the probability of loss of data stored in virtual volumes other than the virtual volumes with low importance.

According to the present invention, since it is possible to reduce the probability of loss of data stored in virtual volumes other than the virtual volumes with low importance, it is possible to realize a storage apparatus and its control method capable of improving the maintainability of important data.

### DESCRIPTION OF DRAWINGS

FIG. 1 is a block diagram showing the overall configuration of a computer system according to the first to third embodiments of the present invention;

FIG. 2 is a conceptual diagram explaining the method of managing a storage area in a storage apparatus;

FIG. 3 is a conceptual diagram explaining the AOU function;

FIG. 4 is a block diagram explaining the various programs and various tables stored in a memory of the storage apparatus;

FIG. 5 is a chart showing a real volume management table;

FIG. 6 is a chart showing a virtual volume management table;

FIG. 7 is a chart showing an allocated chunk management table;

FIG. 8 is a chart showing a pool management table;

FIG. 9 is a chart showing a parity group management table;

FIG. 10 is a schematic diagram showing a virtual volume creation screen;

FIG. 11 is a flowchart showing a processing routine of the access request reception processing;

FIG. 12 is a flowchart showing a processing routine of the chunk allocation processing;

FIG. 13 is a flowchart showing a processing routine of the high importance volume allocation processing;

FIG. 14 is a chart explaining the high importance volume allocation processing;

FIG. 15 is a chart explaining the high importance volume allocation processing;

FIG. 16 is a chart explaining the high importance volume allocation processing;

FIG. 17 is a chart explaining the high importance volume allocation processing;

FIG. 18 is a chart explaining the high importance volume allocation processing;

FIG. 19 is a chart explaining the high importance volume allocation processing;

FIG. 20 is a flowchart showing a processing routine of the virtual volume migration processing;

FIG. 21 is a flowchart showing a processing routine of the mid importance volume allocation processing;

FIG. 22 is a flowchart showing a processing routine of the low importance volume allocation processing;

FIG. 23 is a chart showing a pool remaining capacity monitoring table;

FIG. 24 is a flowchart showing a processing routine of the pool remaining capacity monitoring processing;

FIG. 25 is a conceptual diagram explaining the chunk reallocation processing;

FIG. 26 is a conceptual diagram explaining the chunk reallocation processing;

FIG. 27 is a conceptual diagram explaining the chunk reallocation processing;

FIG. 28 is a flowchart showing a processing routine of the chunk reallocation processing;

FIG. 29 is a flowchart showing a processing routine of the failed volume recovery processing;

FIG. 30 is a flowchart showing a processing routine of the high importance volume recovery processing;

FIG. 31 is a chart explaining the chunk allocation processing according to the second embodiment;

FIG. 32 is a chart showing a virtual volume management table according to the second embodiment;

FIG. 33 is a chart showing a pool management table according to the second embodiment;

FIG. 34 is a schematic diagram showing a virtual volume creation screen according to the second embodiment;

FIG. 35 is a flowchart showing a processing routine of the high importance volume allocation processing according to the second embodiment;

FIG. 36 is a flowchart showing a processing routine of the mid importance volume allocation processing according to the second embodiment;

FIG. 37 is a flowchart showing a processing routine of the low importance volume allocation processing;

FIG. 38 is a flowchart showing a processing routine of the chunk pre-allocation processing; and

FIG. 39 is a conceptual diagram explaining a chunk pre-allocation program.

### DETAILED DESCRIPTION

An embodiment of the present invention is now explained in detail with reference to the attached drawings.

### First Embodiment

### (1-1) Configuration of Computer System of Present Embodiment

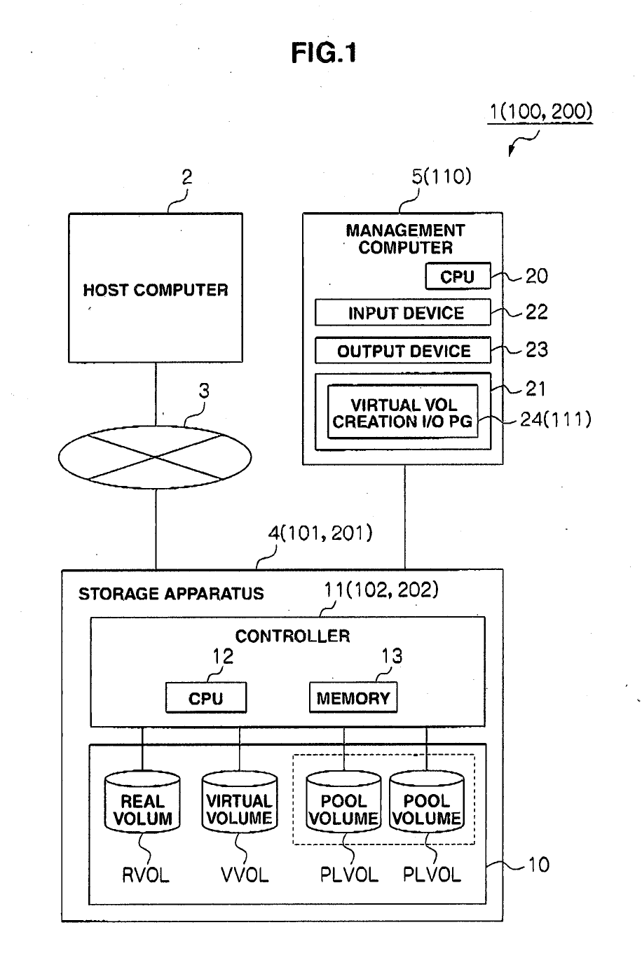

FIG. 1 shows the overall computer system 1 according to the present embodiment. The computer system 1 is configured by a host computer 2 being connected to a storage apparatus 4 via a network 3 such as a SAN (Storage Area Network), and a management computer 5 being connected to the storage apparatus 4.

The host computer 2 is a computer device comprising information processing resources such as a CPU (Central Processing Unit) and a memory, and is configured from a personal computer, a workstation a mainframe or the like.

The storage apparatus 4 comprises a storage unit 10 configured from a plurality of hard disk devices (HDD: Hard Disk Drives), and a controller 11 for controlling the input and output of data into and from the storage unit 10.

Each hard disk device of the storage unit 10 is configured from an expensive disk such as a SCSI (Small Computer System Interface) disk or an inexpensive disk such as a SATA (Serial AT Attachment) disk. Volumes as one or more logical storage areas are associated with the storage areas provided by the hard disk devices. A unique identifier (referred to as a volume ID) is assigned to each volume, and the respective volumes are managed using the volume ID.

As attributes of the volumes to be created in the storage apparatus 4, there are real volumes RVOL, virtual volumes WOL and pool volumes PLVOL. A real volume RVOL is a tangible volume, and is allocated with a storage area in advance in the amount of the capacity. A virtual volume WOL is a virtual volume that is intangible when it is initially created, and a storage area is dynamically allocated thereto according to the usage status. A pool volume PLVOL is an aggregate of storage areas allocated to the virtual volume VVOL.

The controller 11 comprises information processing resources such as a CPU 12 and a memory 13, a cache memory for temporarily storing data to be read from and written into the volumes, and so on. The controller 11 controls the reading and writing of data from and into a designated volume according to an access request (read request and write request) from the host computer 2.

The management computer 5 comprises information processing resources such as a CPU 20 and a memory 21, an input device 22 configured from a keyboard, a mouse and the like, and an output device 23 configured from a CRT (Cathode-Ray Tube) or an LCD (Liquid Crystal Display). The CPU 20 is a processor for governing the overall operational control of the management computer 5, and executes necessary processing based on various control programs stored in the memory 21. The memory 21 is used for primarily storing control programs and control parameters. The virtual volume creation I/O program 24 described later is also stored in the memory 21.

### (1-2) Chunk Allocation Processing

### (1-2-1) Management Method of Storage Area in Computer System

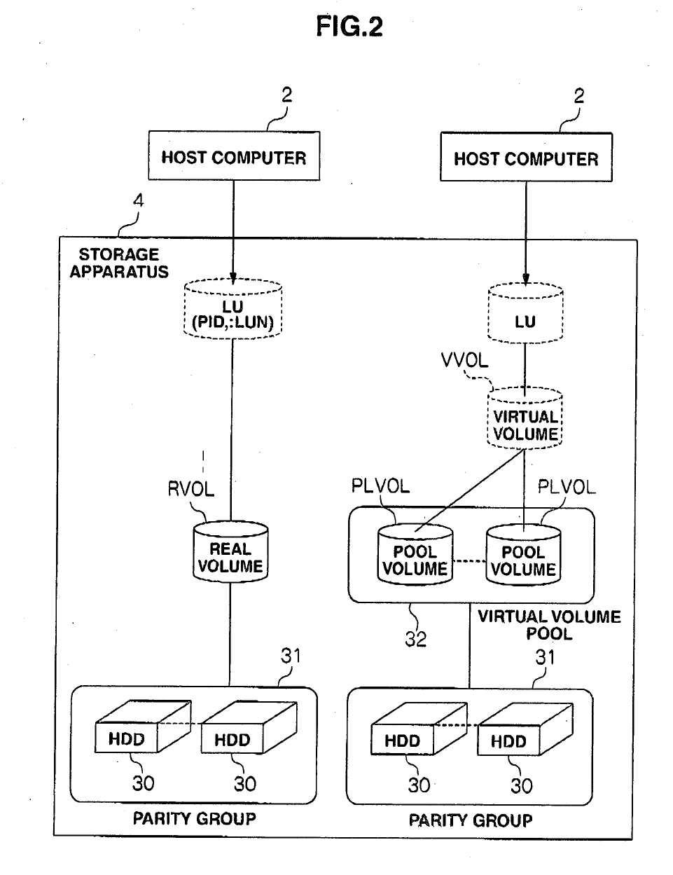

The method of managing storage areas in the storage apparatus 4 of the computer system 1 is now explained with reference to FIG. 2.

As shown in FIG. 2, the host computer 2 recognizes the storage areas provided by its storage apparatus 4 as logical storage areas referred to as logical units LU. Upon accessing its intended logical unit LU, the host computer 2 sends to the storage apparatus 4 an access request designating a port ID (hereinafter referred to as “PID” (Port Identification)) of the I/O port associated with that logical unit LU, an identifier (hereinafter referred to as “LUN” (Logical Unit Number)) of that logical unit LU, and an address of the access destination in that logical unit LU.

Meanwhile, the storage apparatus 4 operates a plurality of (for instance, four) hard disk devices 30 in the storage unit 10 as one parity group 31, and further operates the hard disk devices 30 in RAID (Redundant Array of Inexpensive Disks) format in parity group units. A system administrator is able to set an intended RAID level (“RAID 0,” “RAID 1,” “RAID 1+0,” “FRAID 2” to “RAID 6”) to each parity group 31.

Among the parity groups 31 defined in the storage apparatus 4, a real volume RVOL is defined in the storage areas provided by the parity groups 31 for real volumes, and the real volume RVOL is associated with the foregoing logical unit LU.

Consequently, if the storage apparatus 4 receives an access request to the logical unit LU associated with the real volume RVOL, it reads and writes data from and into the corresponding address location in the corresponding real RVOL (to be precise, the corresponding address location in the storage area provided by the corresponding parity group 31).

Moreover, among the parity groups 31 in the storage apparatus 4, each of the storage areas provided by the respective parity groups 31 for virtual volumes is managed as one pool volume PLVOL. The storage apparatus 4 collectively manages one or more pool volumes PLVOL as one pool 32.

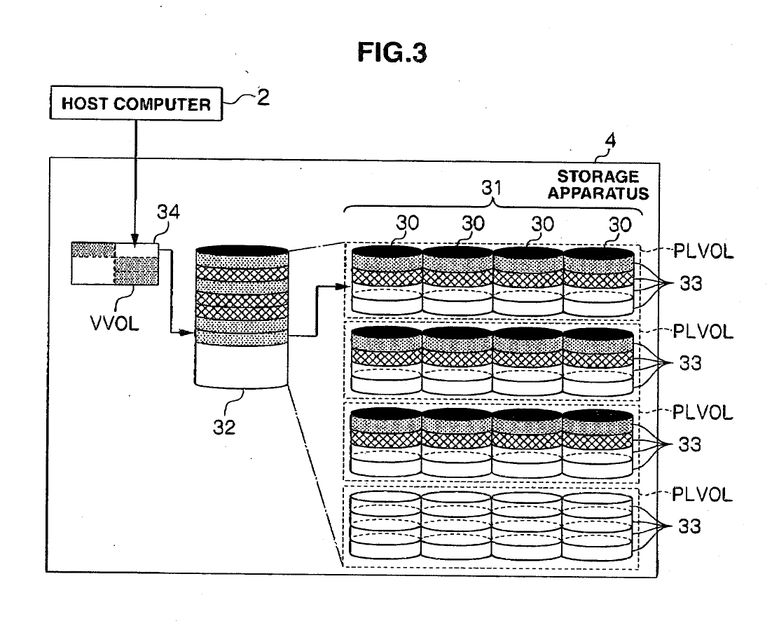

Here, as shown in FIG. 3, the storage areas in the pool volume PLVOL are partitioned and managed into fixed-length small areas referred to as chunks 33. The storage areas in the virtual volume VVOL are partitioned and managed in management units referred to as data blocks 34 having the same capacity as the chunks 33. The data blocks 34 are the smallest units upon reading and writing data from and into the virtual volume VVOL. An identifier referred to as an LBA (Logical Block Address) is assigned to each data block 34.

When the storage apparatus 4 receives an access request to a logical unit LU associated with the virtual volume VVOL, it converts this access request into an access request to a virtual volume VVOL, and reads and writes data from and into the chunk 33 allocated to the corresponding data block 34 in the corresponding virtual volume VVOL based on the converted access request.

In this case, if the access request is a write request to a virtual volume VVOL to which a chunk 33 has not yet been allocated, the storage apparatus 4 allocates a chunk 33 in the pool volume PLVOL configured from one of the parity groups 31 to the data block 34, and writes the write-target data, which is to be written into the data block 34, into the chunk 33.

Like this, with the storage apparatus 4, by dynamically allocating a storage area (chunk 33) to the virtual volume VVOL, it is possible to effectively use the storage areas provided by the hard disk device 30 mounted on the storage apparatus 4.

### (1-2-2) Chunk Allocation Function in Present Embodiment

The chunk allocation function loaded in the storage apparatus 4 according to the present embodiment is now explained.

With the computer system I of this embodiment, the system administrator is able to set the importance to the respective virtual volumes VVOL, A characteristic of the computer system 1 this embodiment is in that, when the storage apparatus 4 is to allocate a chunk 33 to the virtual volume VVOL, the chunk 33 is allocated based on rules according to the importance of that virtual volume VVOL.

Another characteristic of the computer system 1 of this embodiment is that the storage apparatus 4 manages the quality level of the storage areas (chunks 33) provided by the respective parity groups 31, and allocates chunks 33 of a parity group 31 with a relatively high quality level to a virtual volume VVOL with relatively, high importance, and allocates chunks 33 of a parity group 31 with a relatively low quality level to a virtual volume VVOL with relatively low importance.

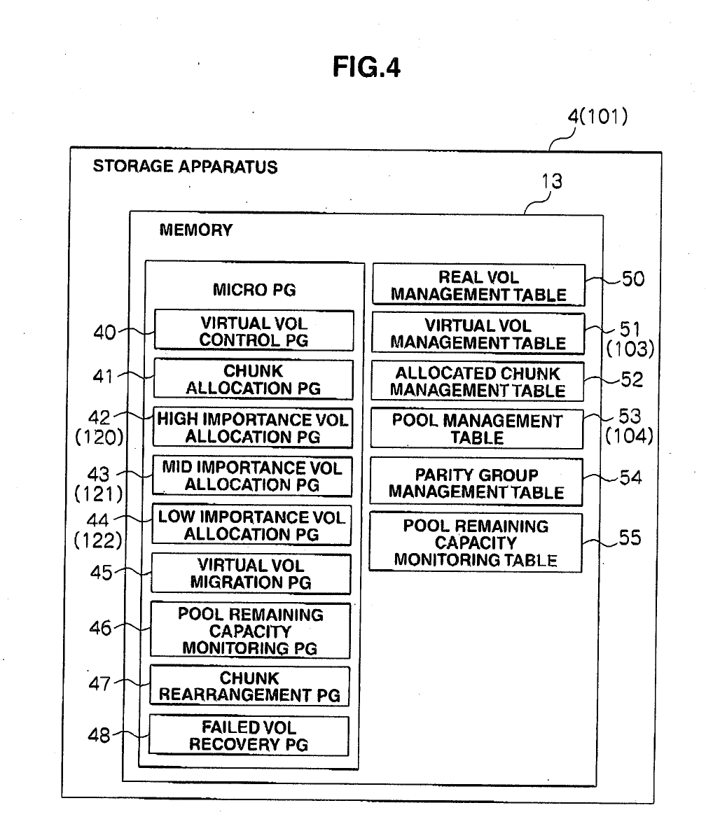

As means for the storage apparatus 4 to execute the foregoing processing, the memory 13 of the storage apparatus 4 stores, as shown in FIG. 4, micro programs including a virtual volume control program 40, a chunk allocation program 41, a high importance volume allocation program 42, a mid importance volume allocation program 43, a low importance volume allocation program 44, a virtual volume migration program 45, a pool remaining capacity monitoring program 46, a chunk rearrangement program 47 and a failed volume recovery program 48, as well as a real volume management table 50, a virtual volume management table 51, an allocated chunk management table 52, a pool management table 53, a parity group management table 54 and a pool remaining capacity monitoring table 55.

The virtual volume control program 40, the chunk allocation program 41, the high importance volume allocation program 42, the mid importance volume allocation program 43, the low-importance volume allocation program 44, the virtual volume migration program 45, the pool remaining capacity monitoring program 46, the chunk rearrangement program 47 and the failed volume recovery program 48 are programs for executing the various types of processing described later, and the details thereof will be described later.

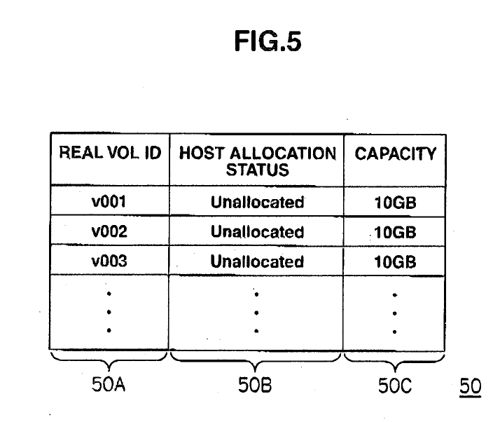

The real volume management table 50 is a table for the controller 11 of the storage apparatus 4 to manage the real volume RVOL (FIG. 1) defined in the storage apparatus 4 and, as shown in FIG. 5, is configured from a real volume ID column 50A, a host allocation status column 508 and a capacity column 50C.

The real volume ID column 50A stores the volume ID assigned to each real volume RVOL set in the storage apparatus 4, the host allocation status column 50B stores host allocation information (“Allocated” when allocated and “Unallocated” when not allocated) representing whether the corresponding real volume RVOL is allocated to the host computer 2. The capacity column 50C stores the capacity of the corresponding real volume RVOL.

Accordingly, for instance, the example of FIG. 5 shows that a real volume RVOL assigned a volume ID of “v001” has not yet been allocated to the host computer 2 (“Unallocated”), and has a capacity of “10GB.

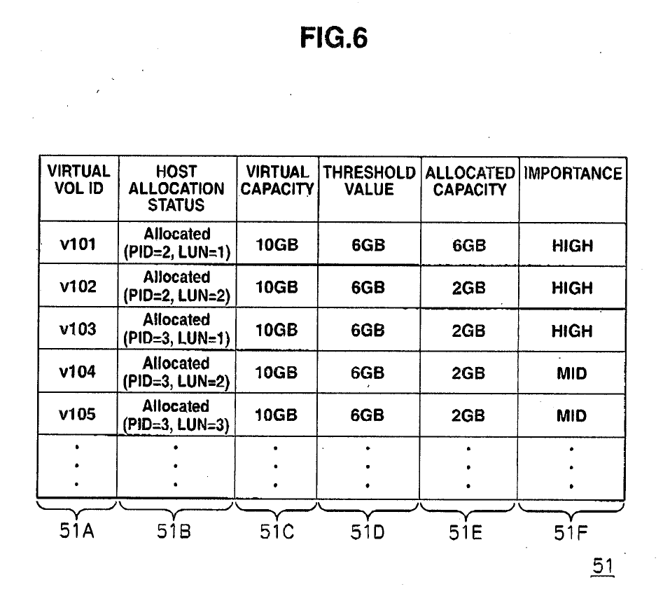

The virtual volume management table 51 is a table for the controller 11 of the storage apparatus 4 to manage the virtual volume VVOL defined in the storage apparatus 4 and, as shown in FIG. 6, is configured from a virtual volume ID column 51A, a host allocation status column 51B, a virtual capacity column 51C, a threshold value column 51D, an allocated capacity column 51E and the importance column 51F.

The virtual volume ID column 51A stores the volume ID of each virtual volume VVOL set in the storage apparatus 4, and the host allocation status column 51B stores the host allocation information representing whether the corresponding virtual volume VVOL is allocated to the host computer 2 via the logical unit LU (FIG. 2), the LUN of the logical unit LU associated with the virtual volume VVOL, and the PID for accessing the logical unit LU, respectively.

The virtual capacity column 51C stores the capacity of the corresponding virtual volume VVOL, and the threshold value column 51D stores the threshold value upon migrating the data stored in the virtual volume VVOL to the real volume RVOL. The allocated capacity column 51E stores the total capacity of the chunk 33 already allocated to the virtual volume VVOL, and the importance column 51F stores the importance set by the system administrator to the virtual volume VVOL. In the case of this embodiment, the importance is set at three levels of “High,” “Mid” and “Low.”

Accordingly, the example of FIG. 6 shows that a virtual volume VVOL assigned with a volume ID of “v101” is allocated with a chunk 33 of “6GB” among the capacity of “10GB” (“Allocated”), the threshold value is set to “6GB” and the importance is set to “High.”

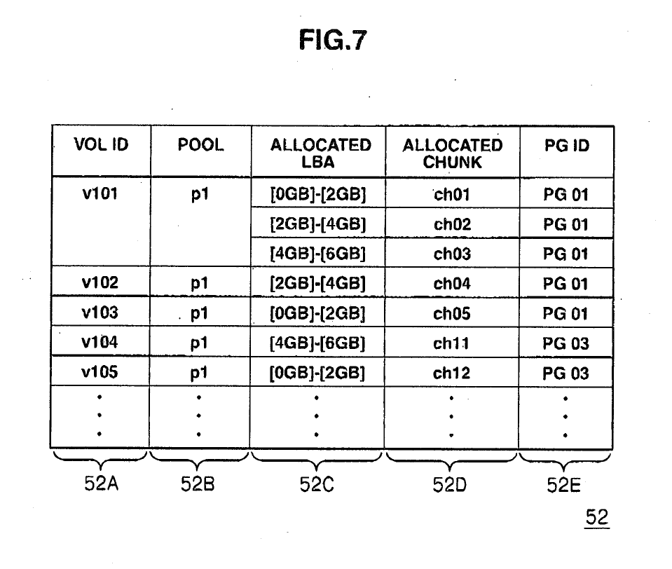

The allocated chunk management table 52 is a table for managing the allocation status of the chunks 33 in the respective virtual volumes VVOL and, as shown in FIG. 7, is configured from a volume ID column 52A, a pool ID column 52B, an allocated LBA column 52C, an allocated chunk column 52D and a parity group ID column 52E.

The volume ID column 52A stores the volume ID of each virtual volume VVOL, and the pool ID column 52B stores an identifier of the pool 31 (FIG. 3) hereinafter referred to as the “pool ID”) in which the corresponding virtual volume VVOL is to receive the provision of the chunk 33. The allocated LBA column 52C stores the range from the volume top of the data block 34, which has already been allocated with a chunk 33, in the corresponding virtual volume VVOL.

The allocated chunk column 52D stores an identifier of the chunk 33 (hereinafter referred to as the “chunk ID”) allocated to the corresponding data block 34 in the virtual volume VVOL, and the parity group ID column 52E stores an identifier (hereinafter referred to as the “parity group ID”) assigned to the parity group 31 providing that chunk 33.

Accordingly, the example of FIG. 7 shows that a virtual volume VVOL assigned with a volume ID of “v101” is to be allocated with a chunk 33 from a pool 32 assigned with a pool ID of “p1,” the chunks 33 assigned with a chunk ID of “ch01,” “ch02” or “ch03” are allocated to the respective ranges of “[0GB] to [2GB],” “(2GB] to [4GB]” and “[4GB]to [6GB]” from the volume top of the virtual volume VVOL, and all of these chunks 33 belong to a pool volume PLVOL provided by the parity group 31 assigned with a parity group ID of “PG01.”

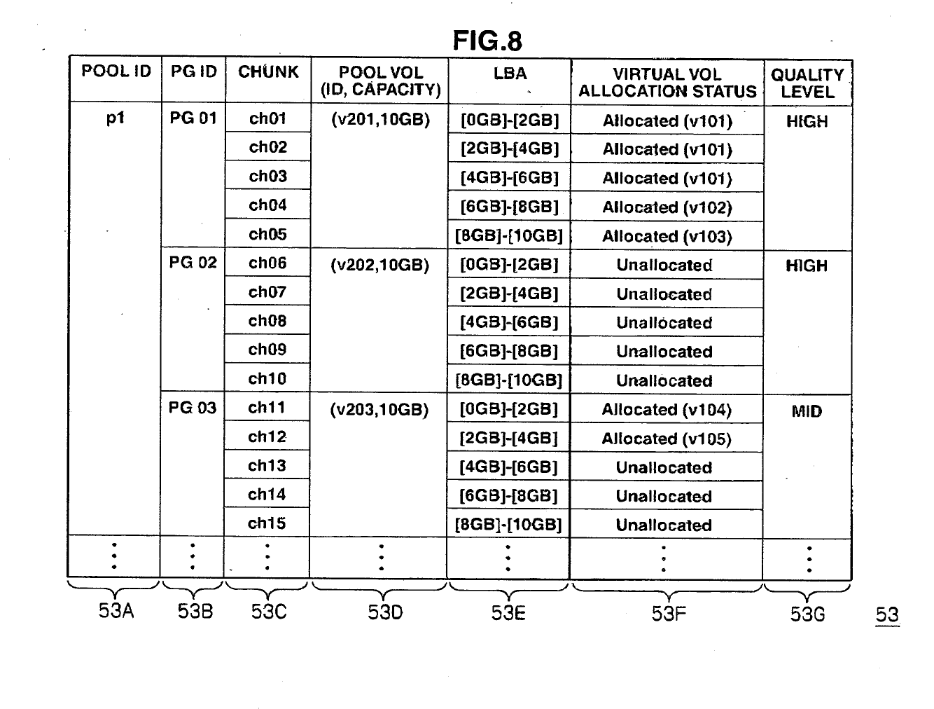

The pool management table 53 is a table for managing the pool 32 (FIG. 3) and, as shown in FIG. 8, is configured from a pool 10 column 53A, a parity group ID column 53B, a chunk column 53C, a pool volume column 53D, an LBA column 53E, a virtual volume allocation status column 53F and a quality level column 53G.

The pool ID column 53A stores an identifier (hereinafter referred to as the “pool ID”) assigned to each pool 32 provided in the self-storage apparatus, and the parity group ID column 53B stores a parity group ID of each parity group 31 (FIG. 3) belonging to the corresponding pool 32.

The chunk column 53C stores a chunk ID assigned to each chunk 33 provided by the corresponding parity group 31, and the pool volume ID column 53D stores a volume ID assigned to the pool volume PLVOL configured from the corresponding parity group 31 as well as its capacity.

The LBA column 53E stores the range from the top volume of each chunk 33 (FIG. 3) defined in the pool volume PLVOL, and the virtual volume allocation status column 53F stores volume allocation status information representing the allocation status to the virtual volume VVOL of the corresponding chunk 33, and a volume ID of the virtual volume VVOL allocated with that chunk 33.

As the type of volume allocation status information, there are, for example, “Allocated” representing the status where that chunk 33 has already been allocated to one of the data blocks 34 (FIG. 3) of one of the virtual volumes VVOL, “Unallocated” representing the status where that chunk 33 has not yet been allocated to any virtual volume VVOL, and “Duplicated” representing the status where that chunk 33 is allocated to one of the data blocks 34 of one of the virtual volumes VVOL together with another chunk 33 for duplication.

The quality level column 53G stores the quality level of the storage area (chunk 33) provided by the pool volume PLVOL configured from the corresponding parity group 31. In the case of this embodiment, the quality level is set to the three levels of “High,” “Mid” and “Low.”

Accordingly, the example of FIG. 8 shows that a pool assigned with a pool ID of “p1” is configured from three parity groups 31 respectively assigned a parity group ID of “PG01,” “PG02” and “PG03,” a volume ID of “v201,” “v202” or “v203” is assigned to each pool volume PLVOL configured by the thee parity groups 31, and the capacity of each pool volume PLVOL is “10GB.” With the example shown in FIG. 8, the pool volume PLVOL assigned a volume ID of “v201” provided by the parity group 31 assigned a parity group ID of “PG01” has a “High” quality level, is configured from five chunks 33 (“ch01” to “ch05”) respectively have a capacity of 2[GB] ([0GB] to [2GB], . . . , [8GB] to [10GB]), and all of these chunks 33 have already been allocated to a virtual volume VVOL assigned a volume ID of “v101” to “v103” (“Allocated”).

The quality level to be stored in the quality level column 53G of the pool management table 53 may be automatically set by the controller 11 of the storage apparatus 3 based on the type of hard disk devices 30 (FIG. 3) configuring the corresponding parity group 31, or the RAID level set to the parity group 31, or set by the system administrator based on the type of hard disk devices 30 configuring the pool volume PLVOL or the usage of the pool volume 31 upon registering the pool volume PLVOL in the storage apparatus 4.

Specifically, with a configuration where hard disk devices 30 such as SCSI disks with high reliability and hard disk devices 30 such as SATA disks with low reliability coexist, the quality level of the pool volume PLVOL provided by a parity group 31 configured from hard disk device 30 with relatively high reliability can be set to “High,” and the quality level of the pool volume PLVOL provided by a parity group configured from other hard disk devices 30 can be set to “Mid.”

If hard disk devices 30 with low reliability are mounted on the storage apparatus 4, the quality level of all pool volumes PLVOL may be set to “Low.” Moreover, if there is a plan to add highly reliable hard disk devices 30 in the future, the quality level of the pool volume PLVOL provided by the parity group 31 configured from those hard disk devices 30 may be initially set to “Mid” and, at the stage of adding the highly reliable hard disk devices 30, the quality level of the pool volume PLVOL provided by the parity group 31 configured from those hard disk device 30 may be set to “High.” Upon adding the hard disk devices 30, the quality level of all pool volumes PLVOL may also be reconfigured.

Further, the quality level of a pool volume PLVOL with a RAID level with relatively high fault tolerance may be set to “High” or “Mid,” and the quality level of a pool volume PLVOL with a RAID level with relatively low fault tolerance may be set to “Mid” or “Low.” For instance, if a pool volume PLVOL with a RAID level of “1” and a pool volume PLVOL with a RAID level of “0” coexist, the quality level of the pool volume PLVOL with a RAID level of “1” may be set to “Mid” and the quality level of the pool volume PLVOL with a RAID level of “0” may be set to “Low.”

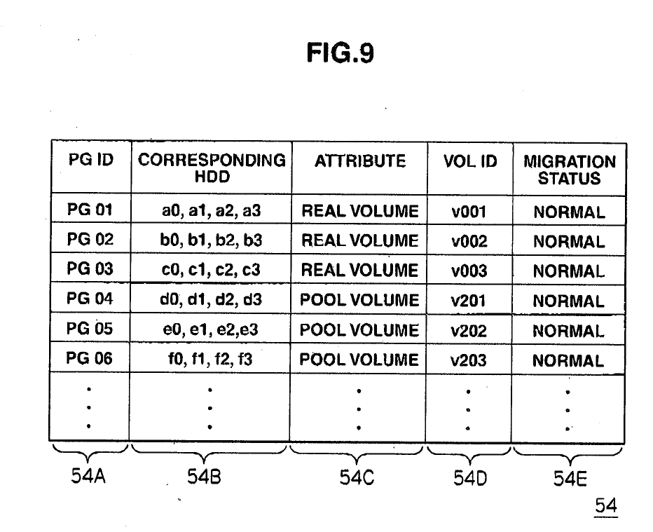

The parity group management table 54 is a table for the controller 11 to manage the parity groups 31 defined in the storage apparatus 4 and, as shown in FIG. 9, is configured from a parity group ID column 54A, a corresponding hard disk device column 54B, an attribute column 54C, a volume ID column 54D and an operating status column 54E.

Among the above, the parity group ID column 54A stores a parity group ID of each parity group 31 defined in the storage apparatus 4, and the corresponding hard disk device column 54B stores an identifier (hereinafter referred to as the “hard disk device ID”) assigned to each hard disk device 4 configuring the corresponding parity group 31.

The attribute column 54C stores an attribute (“real volume” or “pool volume”) of the volume provided by the parity group 31, and the volume ID column 54D stores a volume ID assigned to the volume. The operating status column 54E stores operating status information representing the operating status of that volume (“Normal” when the volume is operating and “Stopped” when the volume is not operating).

Accordingly, the example of FIG. 9 shows that the parity group 31 assigned a parity group ID of “PG01” is configured from four hard disk devices 30 respectively assigned a hard disk device ID of “a0” to “a3,” the volume provided by that parity group 31 is a “real volume” assigned a volume ID of “v001,” and is currently operating (“Normal”).

Details concerning the pool remaining capacity monitoring table 55 will be described later.

### (1-3) Virtual Volume Creation Screen

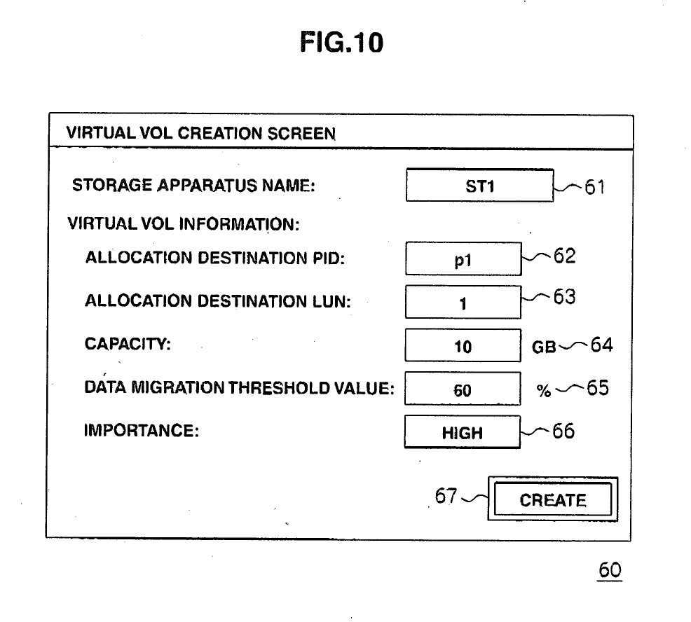

FIG. 10 shows a virtual volume creation screen 60 for creating a virtual volume VVOL in the storage apparatus 4. The virtual volume creation screen 60 can be displayed on the management computer 5 by booting the virtual volume creation I/O program 24 (FIG. 1) loaded in that management computer 5 (FIG. 1).

The virtual volume creation screen 60 is configured from a storage apparatus name input field 61, an allocation destination PID input field 62, an allocation destination LUN input field 63, a capacity input field 64, a data migration threshold value input field 65 and the importance input field 66.

Among the above, the storage apparatus name input field 61 is a filed for inputting a storage apparatus name of the storage apparatus 4 to become the creation destination of the virtual volume VVOL to be created, and the allocation destination PID input field 62 is a field for inputting the PID of the I/O port, among the I/O ports provided to the storage apparatus 4, to become the access destination upon the host computer 2 accessing the logical unit LU (FIG. 2) associated with that virtual volume VVOL.

The allocation destination LUN input field 63 is a field for inputting the LUN of the logical unit LU to be associated with the virtual volume VVOL, and the capacity input field 64 is a field for inputting the capacity of that virtual volume VVOL. The data migration threshold value input field 65 is a field for inputting the data migration threshold value described later, and the importance input field 66 is a field for inputting the importance of the virtual volume VVOL.

By inputting necessary information in the storage apparatus name input field 61, the allocation destination PID input field 62, the allocation destination LUN input field 63, the capacity input field 64, the data migration threshold value input field 65 and the importance input field 66 of the virtual volume creation screen 60, and thereafter clicking the Create button 67, the system administrator is able to send a virtual volume creation request including the various types of information designated in the virtual volume creation screen 60 from the management computer 5 to the creation destination storage apparatus 4 of the virtual volume VVOL.

The controller 11 of the storage apparatus 4 that received the virtual volume creation request creates the virtual volume VVOL designated by the system administrator in the storage apparatus 4 based on the various types of information described above contained in the virtual volume creation request.

Specifically, the controller 11 that received the virtual volume creation request secures an entry (one line of the virtual volume management table 51) for the virtual volume VVOL in the virtual volume management table 51, and stores the volume ID assigned to that virtual volume VVOL in the virtual volume ID column 51A of that entry.

The controller 11 stores the host allocation status information of “Unallocated” representing that the corresponding virtual volume VVOL has not yet been allocated to the host computer 2, the PID of the I/O port for accessing the virtual volume VVOL designated in the virtual volume creation request, and the LUN of the logical unit LU to be associated with that virtual volume VVOL in the host allocation status column 51B of that entry. For instance, in the example of FIG. 10, “p1” is stored as the PID of the I/O port and “1” is stored as the LUN of the logical unit LU in the host allocation status column 51B.

The controller 11 respectively stores corresponding information contained in the virtual volume creation request in the virtual capacity column 51C and the importance column 51F of that entry. For instance, in the example of FIG. 10, “10GB” is stored in the virtual capacity column 51C and “High” is stored in the importance column 51F.

The controller 11 stores the numerical values according to the information of capacity and threshold value contained in the virtual volume creation request in the threshold value column 51D of that entry. For instance, in the example of FIG. 10, since “10GB” is designated as the capacity of the virtual volume VVOL to be created and “60%” is designated as the threshold value, the controller 11 stores the numeral value of “6GB,” which is “60%” of “10GB,” in the threshold value column 51D.

The controller 11 stores the numerical value of “0GB” in the allocated capacity column 51E of that entry. According to the foregoing processing, the virtual volume VVOL designated by the system administrator is created in the storage apparatus 4.

### (1-4) Processing of Controller 11 in Response to Access Request from Host Computer

The processing contents of the controller 11 of the storage apparatus 4 when an access request to the virtual volume VVOL is issued from the host computer 2 are now explained.

(1-4-1) Access Request Reception Processing

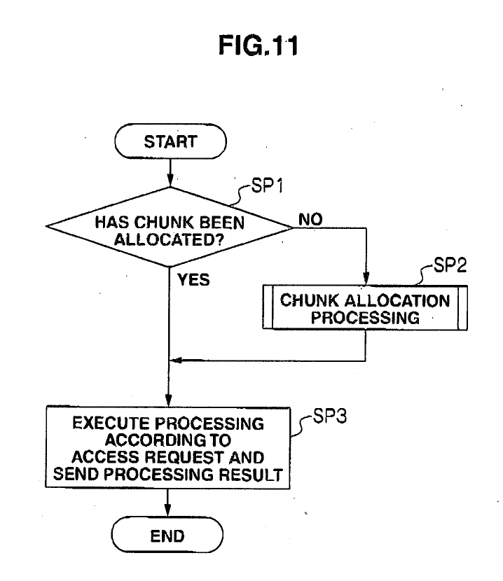

FIG. 11 shows the flow of access request reception processing to be executed by the controller 11 of the storage apparatus 4 that received an access request (read request or write request) to the virtual volume VVOL from the host computer 2. The controller 11 that received the access request executes the access request reception processing shown in FIG. 11 according to the virtual volume control program 40 (FIG. 4) stored in the memory 13 (FIG. 1).

Specifically, the controller 11 starts the access request reception processing when the access request is sent from the host computer 2, and foremost determines whether a chunk 33 (FIG. 3) has already been allocated to the data block 34 (FIG. 3) in the corresponding virtual volume VVOL associated with the access destination designated in the access request (SP1). Here, if the access request is a read request, the controller 11 determines that a chunk 33 has been allocated to the data block 34 of the access destination.

If the controller 11 obtains a positive result in this determination, it proceeds to step SP3. Contrarily, if the controller 11 obtains a negative result in this determination, it boots the chunk allocation program 41 (FIG. 4) stored in the memory 13, and allocates the chunk 33 to the data block 34 by executing the chunk allocation processing described later based on the chunk allocation program 41 (SP2).

Subsequently, the controller 11 executes processing according to the access request, and sends the processing result to the host computer 2 that sent the access request (SP3).

Specifically, if the access request is a read request, the controller 11 reads data from the chunk 33 allocated to the data block 34 associated with the access destination designated in the read request in the virtual volume VVOL associated with the logical unit LU designated in the read request, and sends this data to the source host computer 2 of the access request.

If the access request is a write request, the controller 11 writes the write-target data sent from the host computer 2 together with the write request into the chunk 33 allocated to the data block 34 associated with the access destination designated in the write request in the virtual volume VVOL associated with the logical unit LU designated in the write request, and sends a write processing completion notice to the host computer 2.

The controller 11 thereafter ends this access request reception processing.

(1-4-2) Chunk Allocation Processing

(1-4-2-1) Processing Routine of Chunk Allocation Processing

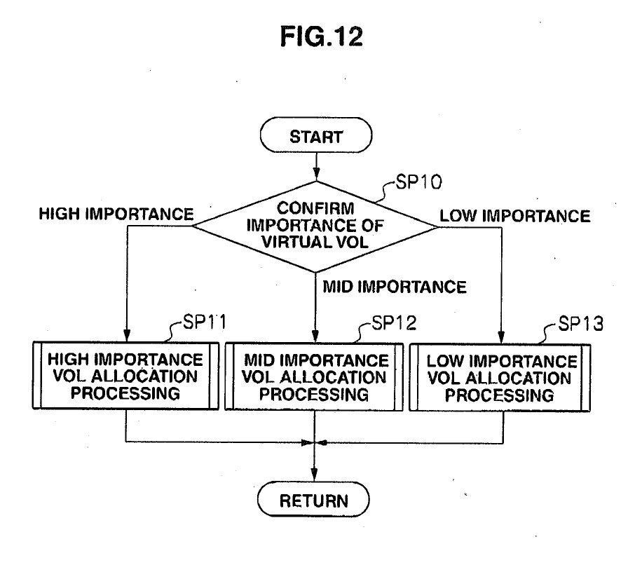

FIG. 12 shows the specific processing contents of the chunk allocation processing to be executed by the controller 11 at step SP2 of the access reception processing.

When the controller 11 proceeds to step SP2 of the access request reception processing, based on the chunk allocation program 41, it refers to the allocated chunk management table 52, and confirms the importance of the virtual volume VVOL associated with the logical unit LU designated in the access request (write request in this case) (SP10).

If the importance of the virtual volume VVOL is “High,” the controller 11 boots the high importance volume allocation program 42 (FIG. 4) and, based on the high importance volume allocation program 42, thereafter allocates the chunk 33 to the data block 34 associated with the access destination designated in the access request in the virtual volume VVOL (SP11). The controller 11 thereafter ends this chunk allocation processing, and returns to the access request reception processing.

If the importance of the virtual volume VVOL is “Mid,” the controller 11 boots the mid importance volume allocation program 43 (FIG. 4) and, based on the mid importance volume allocation program 43, thereafter allocates the chunk 33 to the data block 34 associated with the access destination designated in the access request in the virtual volume VVOL (SP12). The controller 11 thereafter ends this chunk allocation processing, and returns to the access request reception processing.

Moreover, if the importance of the virtual volume VVOL is “Low,” the controller 11 boots the low importance volume allocation program 44 (FIG. 4) and, based on the low importance volume allocation program 44, thereafter allocates the chunk 33 to the data block 34 associated with the access destination designated in the access request in the virtual volume VVOL (SP13) The controller 11 thereafter ends this chunk allocation processing, and returns to the access request reception processing.

(1-4-2-2) High Priority Volume Allocation Processing

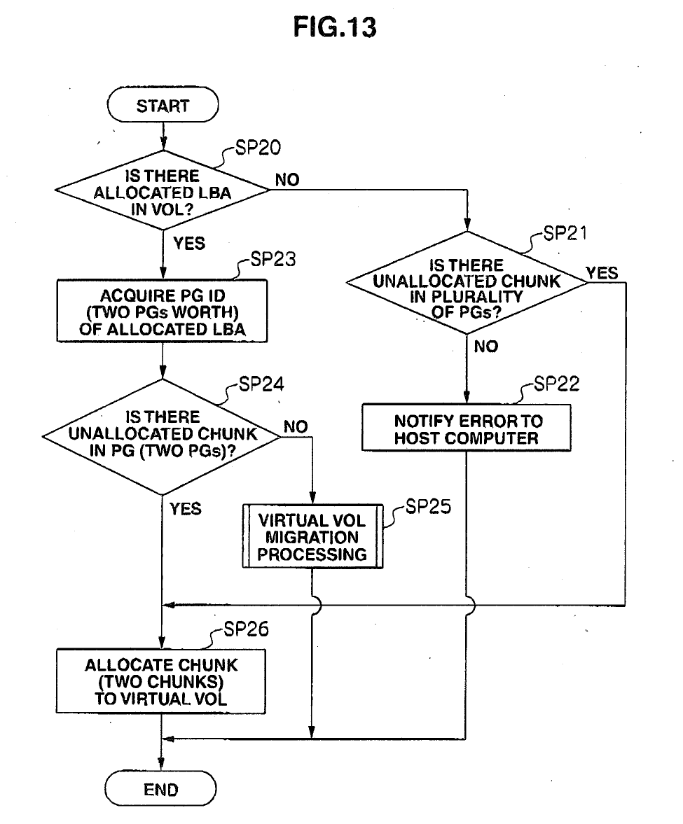

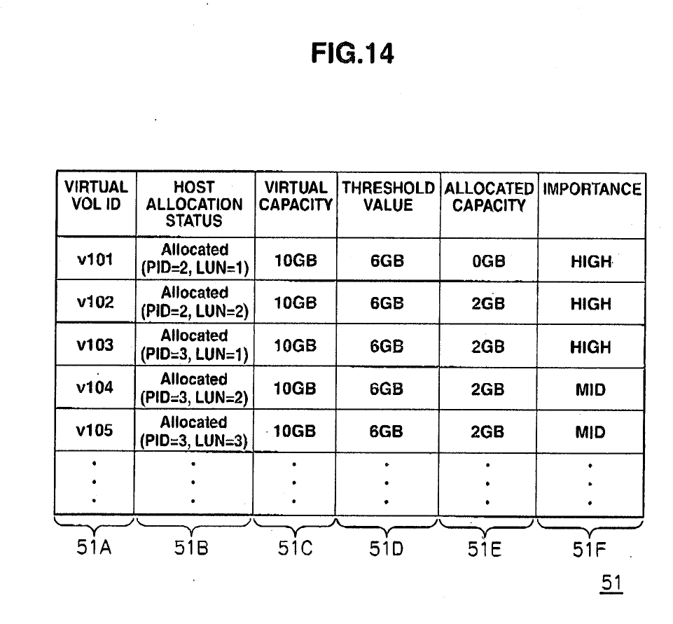

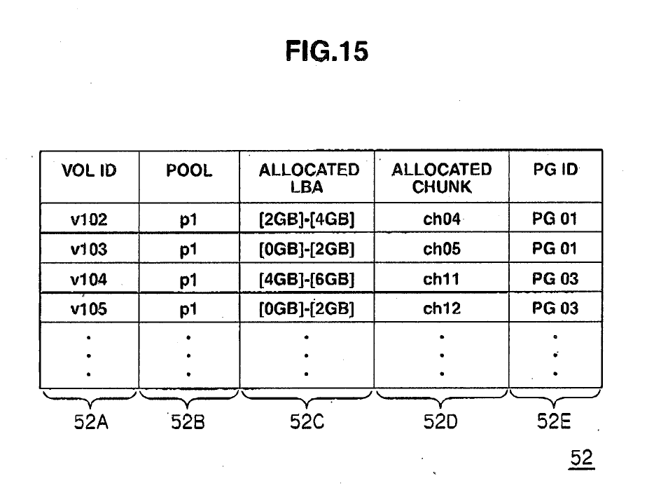

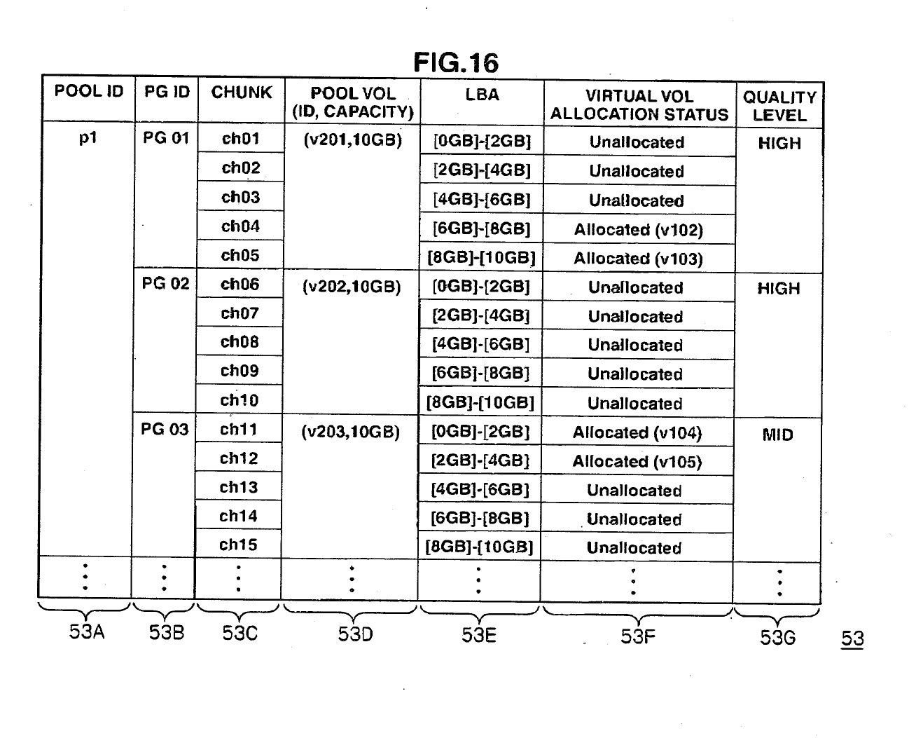

FIG. 13 shows the specific processing contents of the controller 11 at step SP11 of the chunk allocation processing (FIG. 12). In the ensuing explanation, let it be assumed that the initial status of the real volume management table 50, the virtual volume management table 51, the allocated chunk management table 52, the pool management table 53 and the parity group management table 54 is in the status of FIG. 5, FIG. 14, FIG. 15, FIG. 16 and FIG. 9, respectively,

When the controller 11 proceeds to step SP11 of the chunk allocation processing, it starts the high importance volume allocation processing, and foremost refers to the virtual volume management table 51, and determines whether a chunk 33 has already been allocated to the virtual volume VVOL associated with the logical unit LU of the access destination designated in the access request (SP20).

If the controller 11 obtains a negative result in this determination, it refers to the pool management table 53, and determines whether there are two chunks 33 that are provided respectively by at least two different parity groups 31 with a quality level of “High” or “Mid” and which are not allocated to any virtual volume VVOL (SP21).

For instance, in the example of FIG. 16, the chunks 33 provided y the parity group 31 with a “High” quality level are the chunks 33 having a chunk of “ch01” to “ch10” and, among the above, the respective chunks 33 with a chunk ID of “ch01” to “ch05” and the respective chunks 33 with a chunk ID of “ch06” to “ch10” are provided by different parity groups 31 (“PG01” and “PG02”) respectively with a “High” quality level. Since the respective chunks 33 of “ch01” to “ch03” provided by the parity group 31 of “PG01” and the respective chunks 33 of “ch06” to “ch10” provided by the parity group 31 of “PG02” are not allocated to the virtual volume VVOL, two chunks 33 satisfying the conditions at step SP21 exist.

Among the two chunks 33, one chunk 33 is a chunk 33 for reading and writing data from the host computer 2, and the other chunk 33 is a backup chunk 33 for backing up data.

If the controller 11 obtains a negative result in the determination at step SP21, it notifies an access request error to the host computer 2 (SP22). The controller 11 thereafter ends this high importance volume allocation processing, and returns to the chunk allocation processing (FIG. 12).

Meanwhile, if the controller 11 obtains a positive result in the determination at step SP21, it selects the foregoing chunk 33 for reading and writing data and the chunk 33 for backing up data.

For instance, in the example of FIG. 16, the controller 11 selects one chunk 33 among the three chunks 33 assigned a chunk ID of “ch01” to “ch03” provided by the parity group 31 with a parity group ID of “PG01,” and selects one chunk 33 among the five chunks 33 assigned a chunk ID of “ch06” to “ch10” provided by the parity group 31 with a parity group D of “PG02.”

If there are a plurality of candidate chunks 33, the chunks 33 may be selected by any method. In the ensuing explanation, let it be assumed that a chunk 33 with the smallest chunk ID among the candidate chunks 33 is selected. Accordingly, in the example of FIG. 16, the chunk 33 of “ch01” is selected among the three chunks 33 of “ch01” to “ch03” provided by the parity group 31 of “PG01,” and the chunk 33 of “ch06” is selected among the five chunks 33 of “ch06” to “ch10” provided by the parity group 31 of “PG02.”

The controller 11 allocates the two selected chunks 33 to the data blocks 34 corresponding to the access destination designated in the access request in the virtual volume VVOL associated with the logical unit LU designated in the access request (SP26).

Specifically, the controller 11 changes the virtual volume allocation status information stored in the virtual volume allocation status column 53F of the respectively entries, among the respective entries of the pool management table 53 (FIG. 16), corresponding respectively to the two chunks 33 selected as described above from “Unallocated” to “Duplicated,” and additionally stores the volume ID of the virtual volume VVOL of the allocation destination in the virtual volume allocation status column 53F.

The controller 11 additionally registers information concerning these chunks 33 in the allocated chunk management table 52 (FIG. 15). Specifically, the controller 11 secures two new entries in the allocated chunk management table 52, and respectively stores the chunk ID of each chunk 33 allocated to the virtual volume VVOL in the allocated chunk column 52D of the two entries. Further, the controller 11 respectively stores the parity group ID of the parity group 31 providing the corresponding chunk 33 and the pool ID of the pool 32 (FIG. 3) to which that parity group 31 belongs in the parity group ID column 52E and the pool column 52B of the two entries. The controller 11 further respectively stores the volume ID of the virtual volume VVOL and the range (LBA) from the volume top of the data block 34 allocated with the chunk 33 in the virtual volume VVOL in the volume ID column 52A and the allocated LBA column 52C of the two entries.

The controller 11 changes the numerical value stored in the allocated capacity column 51E of the entry corresponding to the virtual volume VVOL of the virtual volume management table 51 (FIG. 14) to the capacity of the chunk 33 allocated to that virtual volume VVOL.

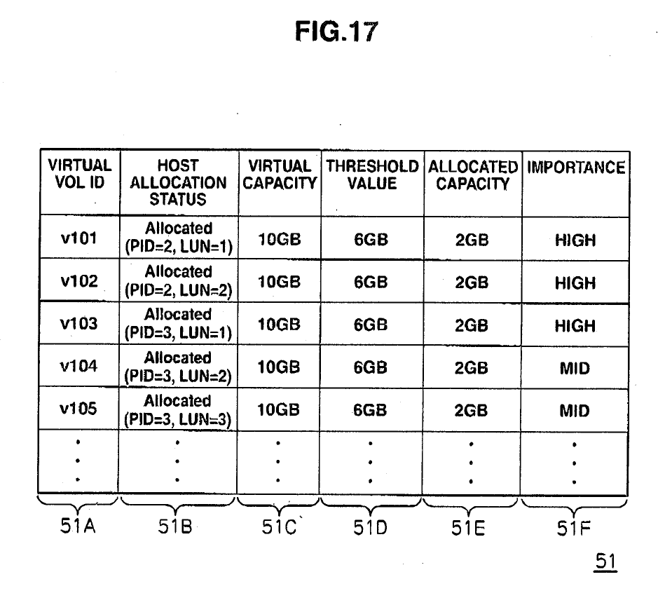

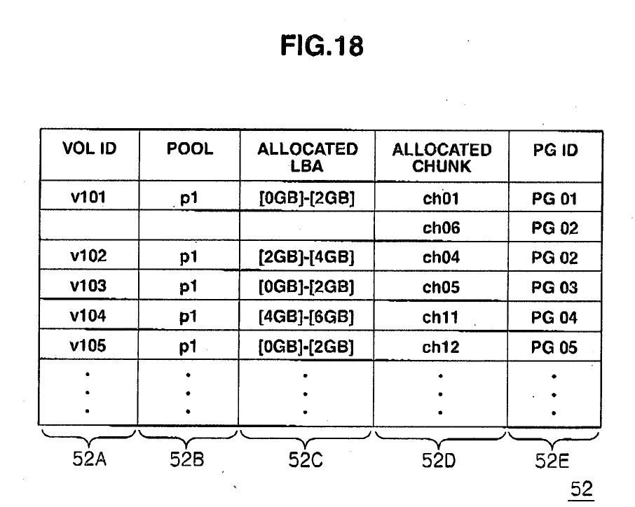

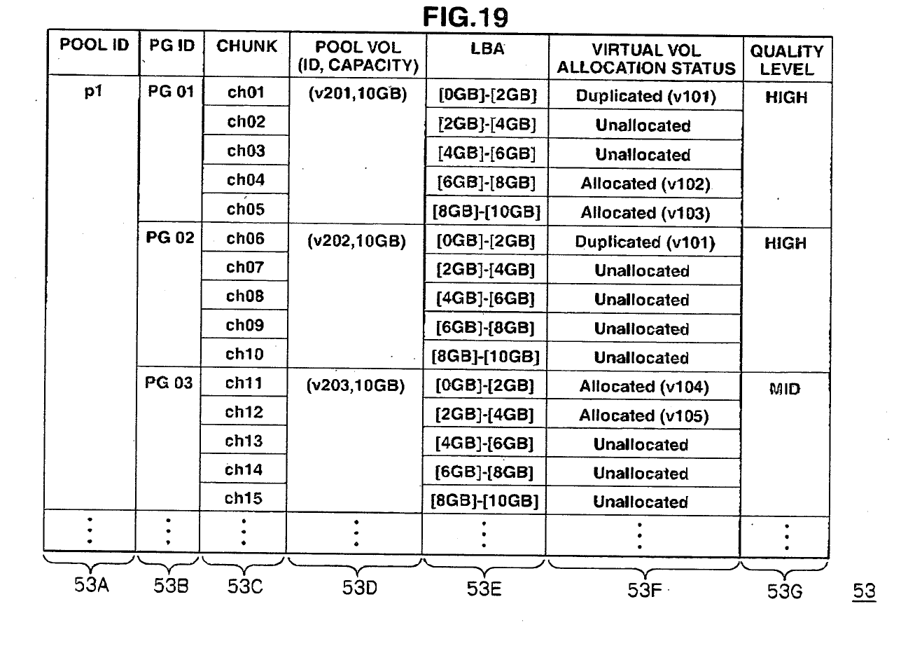

According to the foregoing processing, the virtual volume management table 51, the allocated chunk management table 52 and the pool management table 53 will respectively change from the status of FIG. 14, FIG. 15 and FIG. 16 to the status of FIG. 17, FIG. 18 and FIG. 19. The controller 11 thereafter ends this high importance volume allocation processing, and returns to the chunk allocation processing (FIG. 12).

Meanwhile, if the controller 11 obtains a positive result in the determination at step SP20, it refers to the allocated chunk management table 52, and acquires the parity group ID of the parity group 31 providing the chunk 33 to the virtual volume VVOL associated with the logical unit LU of the access destination designated in the access request (SP23).

Since a “High” importance virtual volume VVOL is allocated with a chunk 33 to be used for reading and writing data and a chunk 33 for backing up data, at step SP23, the controller 11 acquires the parity group ID of each parity group 31 respectively providing the two chunks 33.

For example, if the allocated chunk management table 52 is in the status shown in FIG. 18 and the volume ID of the target virtual volume VVOL is “v101,” the controller 11 refers to the allocated chunk management table 52, and acquires the parity group ID (“PG01”) of the parity group 31 providing the chunk 33 of the chunk ID of “ch01” allocated to the virtual volume VVOL, and the parity group ID (“PG02”) of the parity group 31 providing the chunk 33 of the chunk ID of “ch06” allocated to the virtual volume VVOL.

The controller 11 thereafter refers to the pool management table 53, and determines whether there is a chunk 33 that has not yet been allocated to any virtual volume VVOL in the two parity groups 31 in which the parity group ID was acquired at step SP23 (SP24).

For instance, in the example of FIG. 19, since the two chunks 33 with a chunk ID of “ch02” and “ch03” exist as the chunks 33 that are unallocated to the virtual volume VVOL in the parity group 31 with a parity group ID of “PG01” acquired at step SP23, and the four chunks 33 assigned a chunk ID of “ch07” to “ch010” exist as the chunks 33 that are unallocated to the virtual volume VVOL in the parity group 31 of the parity group ID of “PG02,” a positive result is obtained in this determination.

If the controller 11 obtains a positive result in the determination at step SP24, it allocates the two unallocated chunks 33 provided respectively by the two parity groups 31 detected at step SP23 to the target virtual volume VVOL (SP26), thereafter ends this high importance volume allocation processing, and returns to the chunk allocation processing (FIG. 12).

Contrarily, if the controller 11 obtains a negative result in the determination at step SP24, it boots the virtual volume migration program 45 (FIG. 4) and, based on this virtual volume migration program 45, executes the virtual volume migration processing for migrating the data stored in the target virtual volume VVOL to the real volume RVOL (SP25). This is due to the fact that, so as long as there are no unallocated chunks 33 that have not yet been allocated to any virtual volume VVOL in the two parity groups 31 in which the parity group ID was acquired, there is no choice but to use the read volume RVOL to store data of a “High” importance virtual volume VVOL in the same parity group 31.

The controller 11 thereafter ends this high importance volume allocation processing, and returns to the chunk allocation processing.

When two chunks 33 are allocated to the data block 34 designated in the access request in the virtual volume VVOL designated in the access request as described above, at step SP3 of the access request reception processing in FIG. 11, write-target data is written into these two chunks 33. Thereby, the data written into the “High” importance virtual volume VVOL is duplicated and retained.

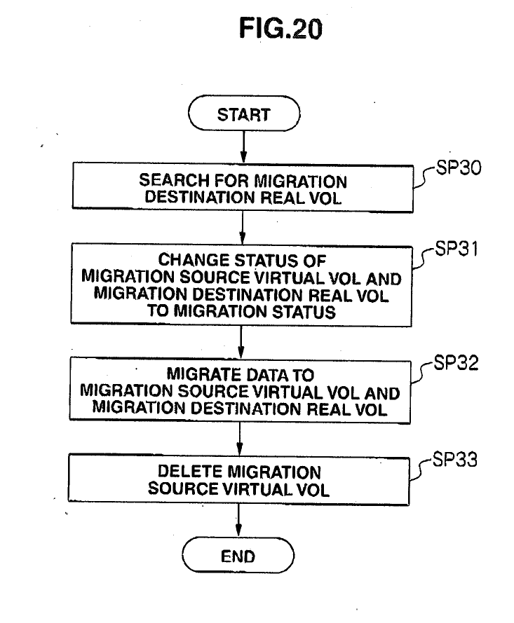

The specific processing contents of the controller 11 at step SP25 of the high importance volume allocation processing are now shown in FIG. 20.

When the controller 11 proceeds to step SP25 of the high importance volume allocation processing, it starts the virtual volume migration processing, foremost refers to the real volume management table 50 (FIG. 5), and then searches for a real volume (hereinafter referred to as the “migration destination real volume”) RVOL of the migration destination to which data stored in the target “High” importance virtual volume VVOL (hereinafter referred to as the “migration source virtual volume”) is to be migrated (SP30).

Subsequently, the controller 11 changes the status of the migration source virtual volume VVOL and the migration destination real volume RVOL to the migration status (SP31), and thereafter migrates the data stored in the migration source virtual volume VVOL from the migration source virtual volume VVOL to the migration destination real volume RVOL (SP32).

Subsequently, the controller 11 deletes the migration source virtual volume VVOL by erasing the entry corresponding to the migration source virtual volume VVOL in the virtual volume management table 51 (SP33). The controller 11 thereafter ends this virtual volume migration processing and returns to the high importance volume allocation processing (FIG. 13).

(1-4-2-3) Mid Priority Volume Allocation Processing

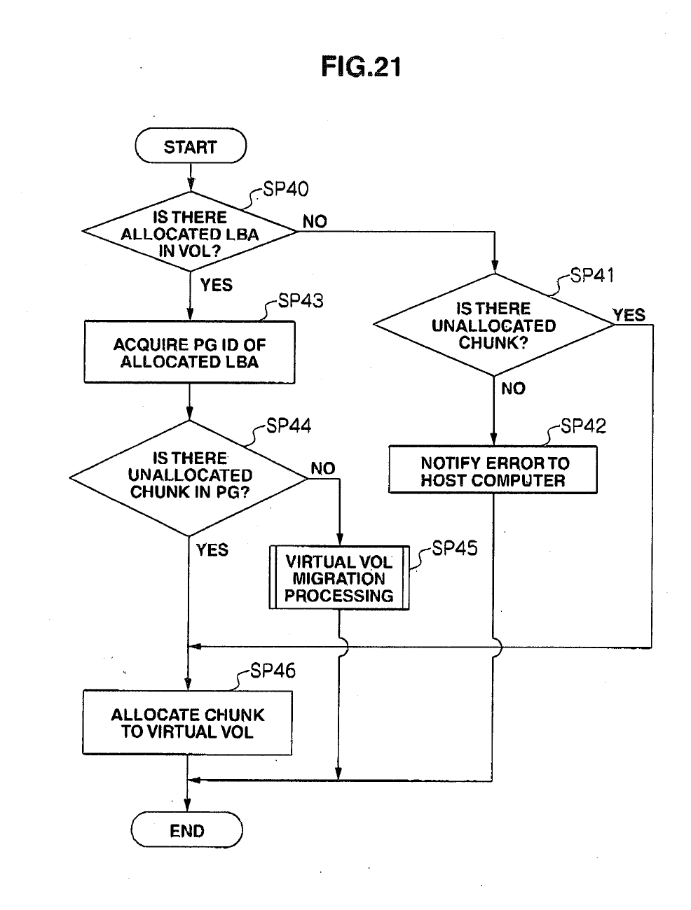

Meanwhile, FIG. 21 shows the specific processing contents of the controller 11 at step SP12 of the chunk allocation processing explained with reference to FIG. 12. In the ensuing explanation, let it be assumed that the initial status of the real volume management table 50, the virtual volume management table 51, the allocated chunk management table 52, the pool management table 53 and the parity group management table 54 is as shown in FIG. 5, FIG. 6, FIG. 7, FIG. 8 and FIG. 9, respectively.

The mid importance volume allocation processing differs from the high importance volume allocation processing explained with reference to FIG. 11 in that only one chunk 33 is allocated to the data block 34 corresponding to the access destination designated in the access request in the virtual volume VVOL associated with the logical unit LU designated in the access request, and the remainder is the same as the high importance volume allocation processing.

Specifically, the controller 11 starts the mid importance volume allocation processing upon proceeding to step SP12 of the chunk allocation processing, foremost refers to the virtual volume management table 51, and determines whether a chunk 33 has already been allocated to the virtual volume VVOL of the access destination designated in the access request (SP40).

If the controller 11 obtains a negative result in this determination, it refers to the pool management table 53, and determines whether there is a chunk 33 that is provided by a parity group 31 with a quality level of “High” or “Mid” and which is not allocated to any virtual volume VVOL (SP41).

If the controller 11 obtains a negative result in the determination at step SP41, it notifies an access request error to the host computer 2 (SP42). The controller 11 thereafter ends this mid importance volume allocation processing, and returns to the chunk allocation processing (FIG. 12).

Meanwhile, if the controller 11 obtains a positive result in the determination at step SP41, it selects one chunk 33 that satisfies the conditions at step SP41. For instance, in the example of FIG. 8, the chunks 33 respectively assigned a chunk ID of “ch11” to “ch15” are the chunks 33 provided by the parity group 31 with a “Mid” quality level, and the respective chunks 33 of “ch13” to “ch15” are not allocated to the virtual volume VVOL. Accordingly, the controller 11 may select one chunk 33 among these chunks 33.

The controller 11 allocates the selected chunk 33 to the data block 34 designated in the access request in the virtual volume VVOL designated in the access request (SP46).

Specifically, the controller 11 changes the virtual volume allocation status information stored in the virtual volume allocation status column 53F of the entry, among the respective entries of the pool management table 53, corresponding the chunk 33 selected as described above from “Unallocated” to “Allocated,” and additionally stores the volume ID of the virtual volume VVOL of the allocation destination in the virtual volume allocation status column 53F.

The controller 11 additionally registers information concerning the chunks 3 in the allocated chunk management table 52. Specifically, the controller 11 secures one new entry in the allocated chunk management table 52, and stores the chunk ID of the chunk 33 allocated to the virtual volume VVOL in the allocated chunk column 52D of that entry. Further, the controller 11 respectively stores the parity group ID of the parity group 31 providing the corresponding chunk 33 and the pool 10 of the pool 32 to which that parity group 31 belongs in the parity group ID column 52E and the pool column 52B of that entry The controller 11 further stores the volume ID of the virtual volume VVOL and the range (LBA) from the volume top of the data block 34 allocated with the chunk 33 in the virtual volume VVOL in the volume ID column 52A and the allocated LBA column 52C of that entry.

The controller 11 changes the numerical value stored in the allocated capacity column 51E of the entry corresponding to the virtual volume VVOL of the virtual volume management table 51 to the capacity of the chunk 33 allocated to that virtual volume VVOL.

The controller 11 thereafter ends this mid importance volume allocation processing, and returns to the chunk allocation processing.

Meanwhile, if the controller 11 obtains a positive result in the determination at step SP40, it refers to the allocated chunk management table 52, and acquires the parity group ID of the parity group 31 providing the chunk 33 which has been allocated to the virtual volume VVOL associated with the logical unit LU designated in the access request (SP43).

For example, if the allocated chunk management table 52 is in the status shown in FIG. 7 and the volume ID of the target virtual volume VVOL is “v104,” the controller 11 refers to the allocated chunk management table 52, and acquires the parity group ID (“PG03”) of the parity group 31 providing the chunk 33 of the chunk ID of “ch11” allocated to the virtual volume VVOL.

The controller 11 thereafter refers to the pool management table 53, and determines whether there is a chunk 33 that has not yet been allocated to any virtual volume VVOL in the parity group 31 in which the parity group ID was acquired at step SP43 (SP44).

For instance, in the example of FIG. 8, since the three chunks 33 assigned with a chunk ID of “ch13” to “ch15” exist as the chunks 33 that are unallocated to the virtual volume VVOL in the panty group 31 with a parity group ID of “PG03” acquired at step SP43, a positive result is obtained in this determination.

If the controller 11 obtains a positive result in the determination at step SP44, it allocates the chunk 33 provided respectively by the parity group 31 detected at step SP43 to the target virtual volume VVOL (SP46), thereafter ends this mid importance volume allocation processing, and returns to the chunk allocation processing (FIG. 12).

Contrarily, if the controller 11 obtains a negative result in the determination at step SP44, it boots the virtual volume migration program 45 (FIG. 4) and, based on this virtual volume migration program 45, executes the virtual volume migration processing explained with reference to FIG. 20 (SP45). The controller 11 thereafter ends this mid importance volume allocation processing, and returns to the chunk allocation processing.

(1-4-24) Low Priority Volume Allocation Processing

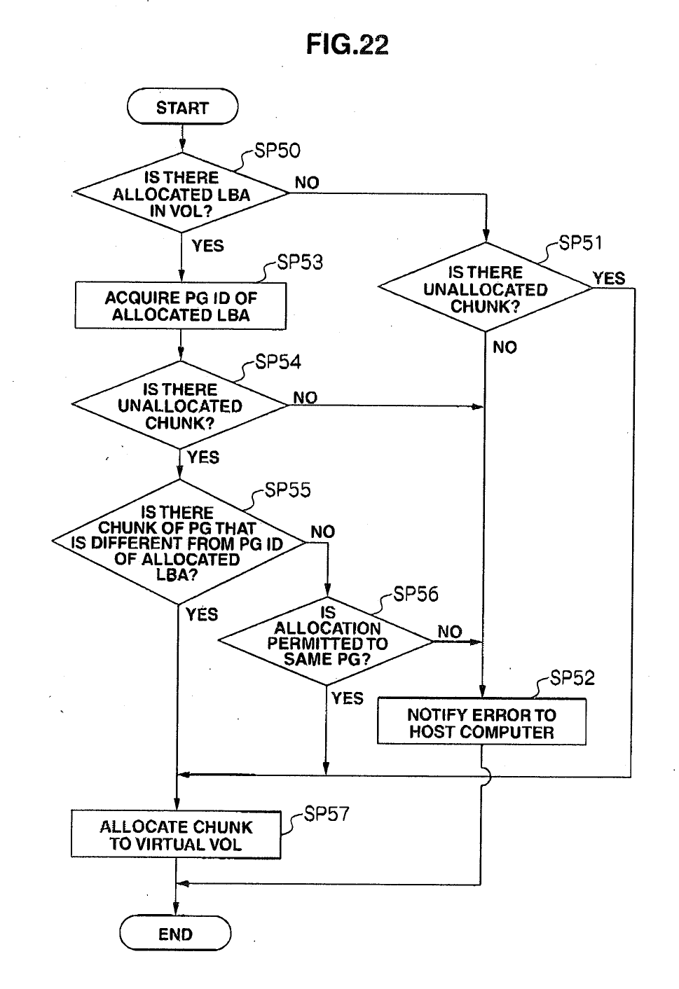

Meanwhile, FIG. 22 shows the specific processing contents of the controller 11 at step SP13 of the chunk allocation processing explained with reference to FIG. 12. This low importance volume allocation processing is the same as ordinary AOU processing.

In other words, the controller 11 starts the low importance volume allocation processing upon proceeding to step SP13 of the chunk allocation processing, foremost refers to the virtual volume management table 51, and determines whether a chunk 33 has already been allocated to the virtual volume VVOL associated with the logical unit LU designated in the access request (SP50).

If the controller 11 obtains a negative result in this determination, it refers to the pool management table 53, and determines whether there is a chunk 33 that is provided by a parity group 31 with a quality level of “Mid” or “Los” and which is not allocated to any virtual volume VVOL (SP51).

If the controller 11 obtains a negative result in the determination at step SP51, it notifies an access request error to the host computer 2 (SP52). The controller 11 thereafter ends this low importance volume allocation processing, and returns to the chunk allocation processing (FIG. 12).

Meanwhile, if the controller 11 obtains a positive result in the determination at step SP51, it selects one chunk 33 that satisfies the conditions at step SP51, and allocates the selected chunk 33 to the data block 34 corresponding to the access destination designated in the access request in the virtual volume VVOL associated with the logical unit LU designated in the access request (SP57). Since the processing contents at step SP57 are the same as the processing contents at step SP47 of the mid importance volume allocation processing explained with reference to FIG. 21, the explanation thereof is omitted. The controller 11 thereafter ends this low importance volume allocation processing, and returns to the chunk allocation lo processing.

Meanwhile, if the controller 11 obtains a positive result in the determination at step SP50, it refers to the allocated chunk management table 52, and acquires the parity group ID of the parity group 31 providing the chunk 33 which has been allocated to the virtual volume VVOL associated with the logical unit LU designated in the access request (SP53).

Subsequently, the controller 11 refers to the pool management table 53, and determines whether there is a chunk 33 that is provided by a parity group 31 with a quality level of “Mid” or “Low” and which is not allocated to any virtual volume VVOL (SP54).

If the controller 11 obtains a negative result in this determination, it proceeds to step SP52. Contrarily, if the controller obtains a positive result in this determination, it refers to the pool management table 53, is determines whether there is a chunk 33 that is not allocated to any virtual volume VVOL and which is provided by a parity group 31 that is different from the parity group 31 assigned with the parity group ID acquired at step SP53 (SP55).

If the controller 11 obtains a positive result in this determination, it proceeds to step SP57. Contrarily, if the controller 11 obtains a negative result in this determination, it determines whether the setting permits the allocation to the virtual volume VVOL of another chunk 33 provided to the same parity group 31 as the parity group 31 already providing the chunk 33 allocated to the virtual volume VVOL associated with the logical unit LU designated in the access request (SP56). This setting is configured in advance by the system administrator.

If the controller 11 obtains a negative result in this determination, it proceeds to step SP52. Contrarily, if the controller 11 obtains a positive result in this determination, it selects a chunk 33 that is not allocated to any virtual volume VVOL among the chunks 33 provided by a parity group 31 that is different from the parity group 31 of the parity group ID detected at step SP53, and allocates this chunk 33 to the data block 34 corresponding to the access destination designated according to the address request of the virtual volume VVOL associated with the logical unit LU designated in the address request (SP57). The controller 11 thereafter ends this low importance volume allocation processing, and returns to the chunk allocation processing.

(14-3) Pool Remaining Capacity Monitoring Processing

Incidentally, if chunks 33 are dynamically allocated sequentially to the virtual volume VVOL based on the foregoing chunk allocation processing, there may eventually be a case where a chunk 33 cannot be allocated to a virtual volume VVOL with the importance of “High” and “Mid” stipulated to be allocated with a chunk 33 provided by the same parity group 31.

Thus, the storage apparatus 4 of this embodiment is loaded with a pool remaining capacity monitoring function for monitoring the remaining capacity of the pool volumes PLVOL respectively configured from the respective parity groups 31, and, at the stage where the remaining capacity (number of chunks unallocated to the virtual volume VVOL) of the pool volume PLVOL with a quality level of “High” or “Mid” becomes smaller than a predetermined threshold value, replacing the chunk 33 provided by a “Mid” quality level parity group 31 allocated to the “Low” quality level virtual volume VVOL with the chunk 33 provided by the “Low” quality level parity group 31.

As means for realizing the pool remaining capacity monitoring function, the memory 13 of the storage apparatus 4 stores, as shown in FIG. 4, a pool remaining capacity monitoring program 46, a pool remaining capacity monitoring table 55, and a chunk rearrangement program 47.

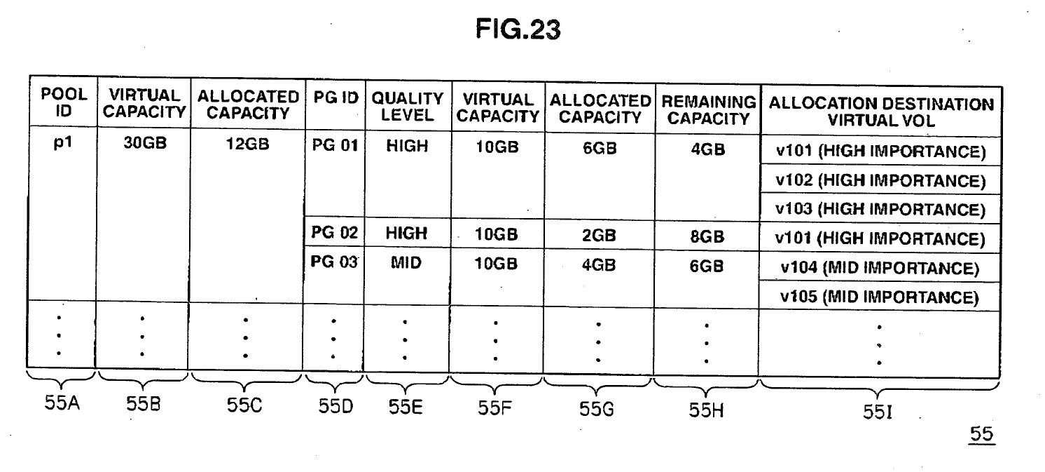

Among the above, the pool remaining capacity monitoring table 55 is a table for the controller 11 to manage the remaining capacity of the respective pool volumes PLVOL and, as shown in FIG. 23, is configured from a pool ID column 55A, a virtual capacity column 55B, an allocated capacity column 55C, a parity group ID column 55D, a quality level column 55E, a virtual capacity column 55F, an allocated capacity column 55G, a remaining capacity column 55H and an allocation destination virtual volume column 551.

The pool ID column 55A stores a pool ID of each pool 32 (FIG. 3) set in the storage apparatus 4, and the virtual capacity column 55B stores the capacity of the overall pool 32. The allocated capacity column 55C stores the total capacity of the chunks 33 allocated in any one of the virtual volumes VVOL among the capacities of the corresponding pools 32.

Meanwhile, the parity group ID column 55D stores the parity group ID of each parity group 31 respectively configuring the pool volume PLVOL belonging to that pool 32, and the quality level column 55E stores the quality level set in the corresponding parity group 31.

The virtual capacity column 55F stores the capacity of the pool volume PLVOL configured from the corresponding parity group 31, and the allocated capacity column 55G and the remaining capacity column 55H respectively store the total capacity of the chunk 33 already allocated to one of the virtual volumes VVOL among the capacities of the respective pool volumes PLVOL and the remaining capacity of the pool volume PLVOL.

The allocation destination virtual volume column 55I stores the volume ID and the importance of the virtual volume VVOL if a chunk 33 provided by the pool volume PLVOL configured from the corresponding parity group 31 is already allocated to one of the virtual volumes VVOL.

Accordingly, the example of FIG. 23 shows that the pool volume PLVOL configured from the three parity groups 31 respectively assigned a parity group ID of “PG01,” “PG02” and “PG03” belongs to the pool 32 with a pool ID of “p1,” and the capacity of the three pool volume PLVOL is respectively “10GB.” FIG. 23 also shows that the remaining capacities of the pool volume PLVOL configured from the parity groups 31 of “PG01” and “PG02” both with a quality level of “High” are respectively “4GB” and “8GB” among the three pool volumes PLVOL, and the remaining capacity of the pool volume PLVOL configured from the parity group 31 of “PG03” is “6GB.”

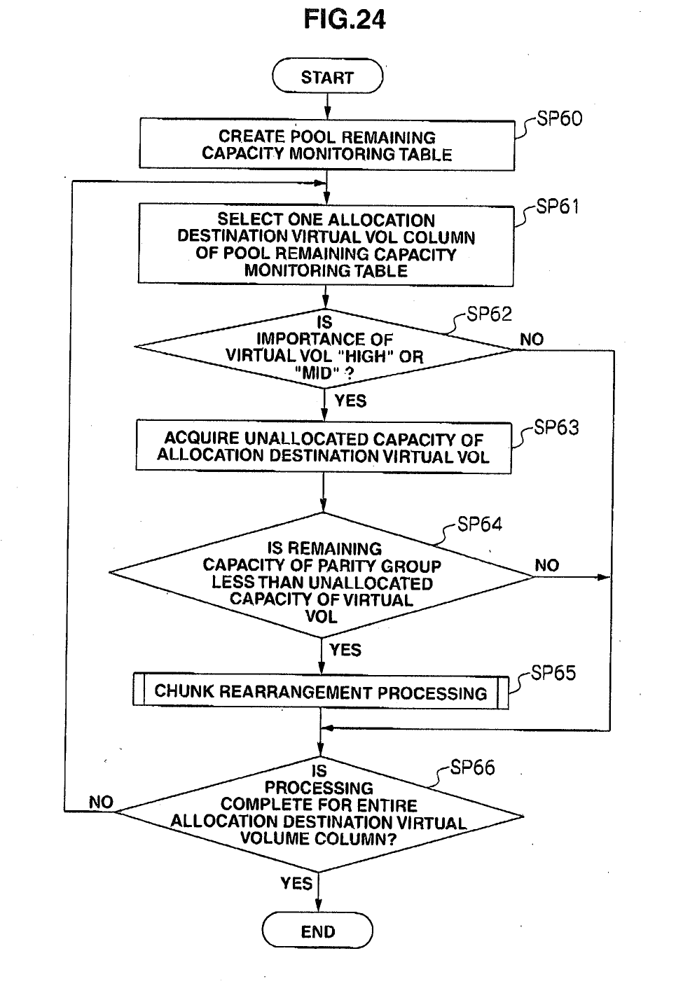

FIG. 24 shows the specific processing contents of the controller 11 concerning the pool remaining capacity monitoring function described above. The controller 11, based on the pool remaining capacity monitoring program 46 (FIG. 4), periodically executes the pool remaining capacity monitoring processing shown in FIG. 24.

Specifically, when the controller 11 starts the pool remaining capacity monitoring processing, it foremost creates the pool remaining capacity monitoring table 55 explained with reference to FIG. 23 based on the virtual volume management table 51 and the pool management table 53 (SP60).

Subsequently, the controller 11 selects one allocation destination virtual volume column 55I of the pool remaining capacity monitoring table 55 (SP61), and determines whether there the importance of the virtual volume VVOL associated with the allocation destination virtual volume column 55I is “High” or “Mid” based on the importance stored in the allocation destination virtual volume column 55I (SP62).

If the controller 11 obtains a negative result in this determination, it proceeds to step SP66. Contrarily, it the controller 11 obtains a positive result in this determination, it calculates the capacity of the chunks 33 unallocated to the virtual volume VVOL (i.e., remaining capacity of the virtual volume VVOL; hereinafter referred to as the “unallocated capacity”) by referring to the virtual capacity column 51C and the allocated capacity column 51E of the corresponding entry of the virtual volume management table 51.

For instance, in the examples of FIG. 6 and FIG. 23, assuming that the allocation destination virtual volume column 55I selected at step SP61 corresponds to the virtual volume VVOL assigned with a volume ID of “v102,” the unallocated capacity of that virtual volume can be calculated to be 8GB (=10GB−2GB) by referring to the corresponding entry of the virtual volume management table 51.

Subsequently, the controller 11 refers to the unallocated capacity column 55H corresponding to the allocation destination virtual volume column 55I selected at step SP61 in the pool remaining capacity monitoring table 55, and determines whether the remaining capacity of the parity group 31 providing the chunk 33 to the virtual volume VVOL is less than the remaining capacity of the virtual volume VVOL calculated at step SP63 (SP64).

For instance, in the foregoing example, since the unallocated capacity of the virtual volume VVOL calculated at step SP63 is 8GB and the remaining capacity of the parity group 31 providing the chunk 33 to the virtual volume VVOL is “4GB,” this means that the unallocated capacity of the virtual volume VVOL calculated at step SP63 is greater than the remaining capacity of the parity group 31 providing the chunk 33 to the virtual volume VVOL.

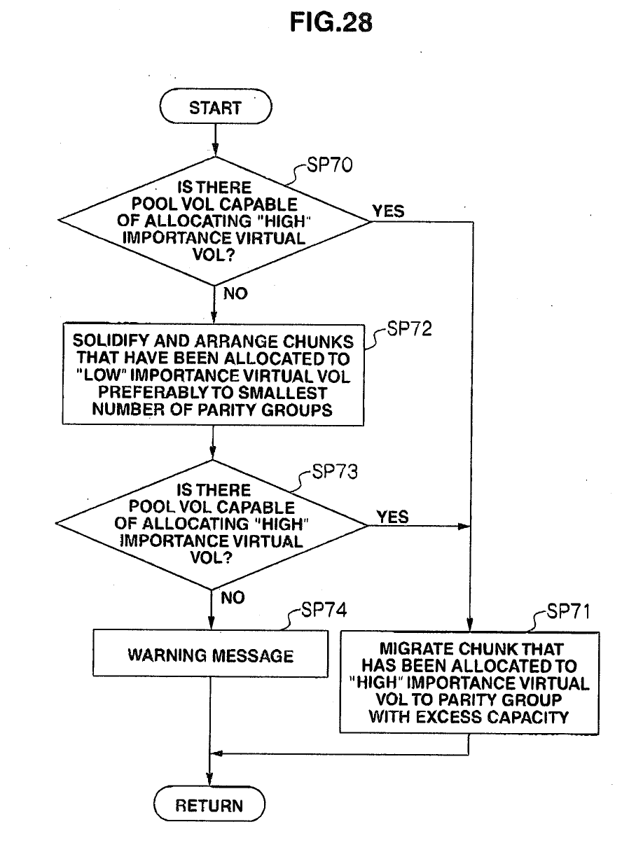

If the controller 11 obtains a negative result in this determination, it proceeds to step SP66. Contrarily, if the controller 11 obtains a positive result in this determination, it executes the chunk rearrangement processing described later with reference to FIG. 28 (SP65). Incidentally, at step SP65, in substitute for the controller 11 executing the chunk rearrangement processing described later, a warning may be notified to the management computer 5, or the virtual volume migration processing explained with reference to FIG. 20 may be executed.

Subsequently, the controller 11 determines whether the same processing has been performed regarding all allocation destination virtual volume columns 551 of the pool remaining capacity monitoring table 55 (SP66). If the controller 11 obtains a negative result in this determination, it returns to step SP61, and thereafter repeats the same processing (SP61 to SP66-SP61).

If the controller 11 obtains a positive result at step SP66 as a result of the same processing being performed regarding all allocation destination virtual volume columns 551 of the pool remaining capacity monitoring table 55, it ends this pool remaining capacity monitoring processing.

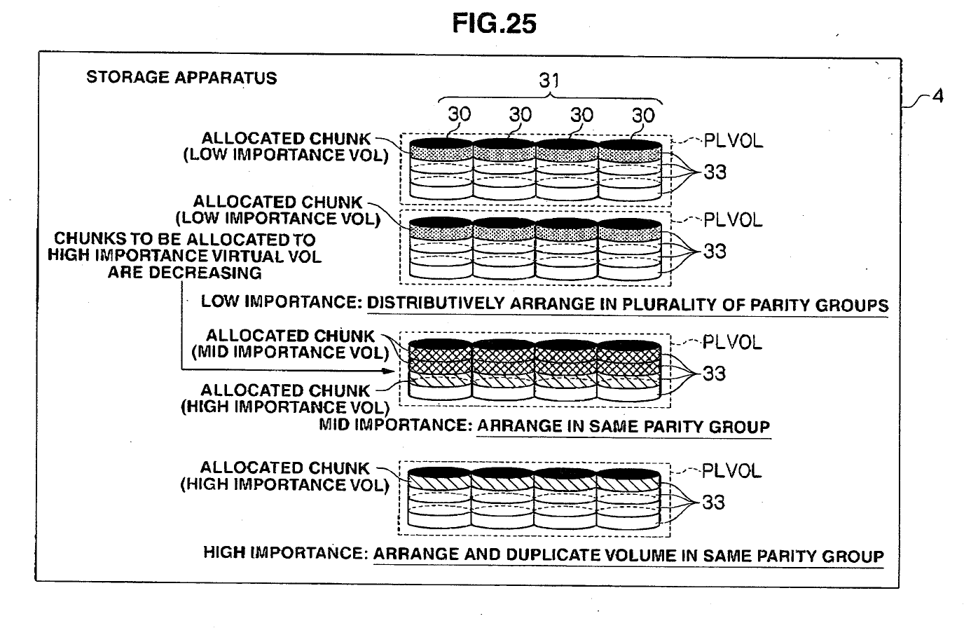

The specific processing contents of the controller 11 regarding the chunk arrangement processing to be performed at step SP65 of the pool remaining capacity monitoring processing are now explained with reference to FIG. 25 to FIG. 27.

As shown in FIG. 25, the storage apparatus 4 of this embodiment distributively allocates the chunks 33 provided by a plurality of parity groups 31 to a “Lo” importance virtual volume VVOL, allocates the chunks 33 provided by the same parity group to a “Mid” importance virtual volume VVOL, and allocates the chunks 33 provided by the same parity group 31 to a “High” importance virtual volume VVOL upon duplicating data.

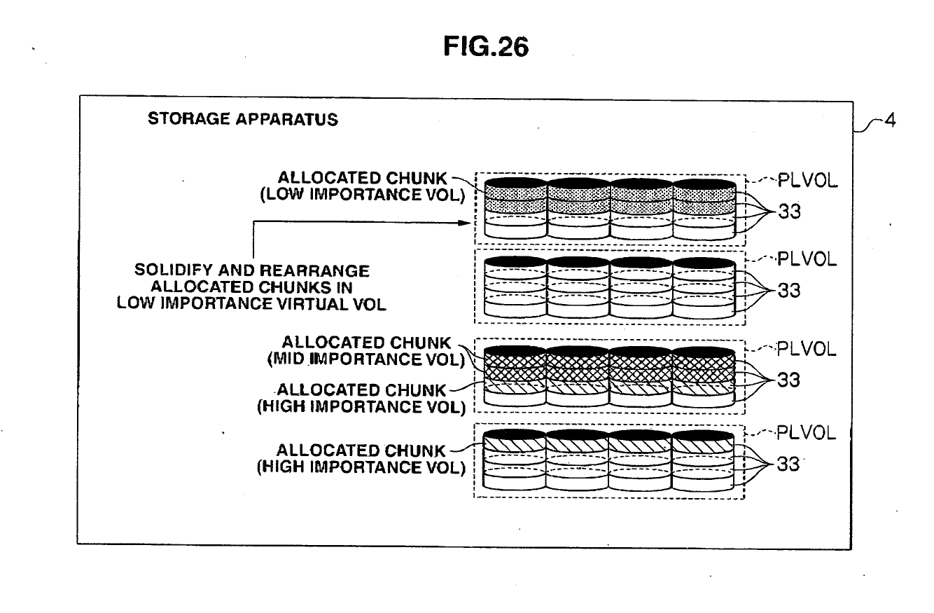

Incidentally, if a chunk 33 provided by a parity group 31 with a “Mid” quality level is allocated to a “Low” importance-virtual volume VVOL, as shown in FIG. 26, the remaining capacity of the parity group 31 with a “Mid” quality level can be increased by reallocating a chunk 33 provided by a parity group 31 with a “Low” quality level (top parity group 31 in FIG. 26) in substitute for the chunk 33 provided by a parity group 31 with a “Mid” quality level (second parity group 31 from the top in FIG. 26) to that virtual volume VVOLF

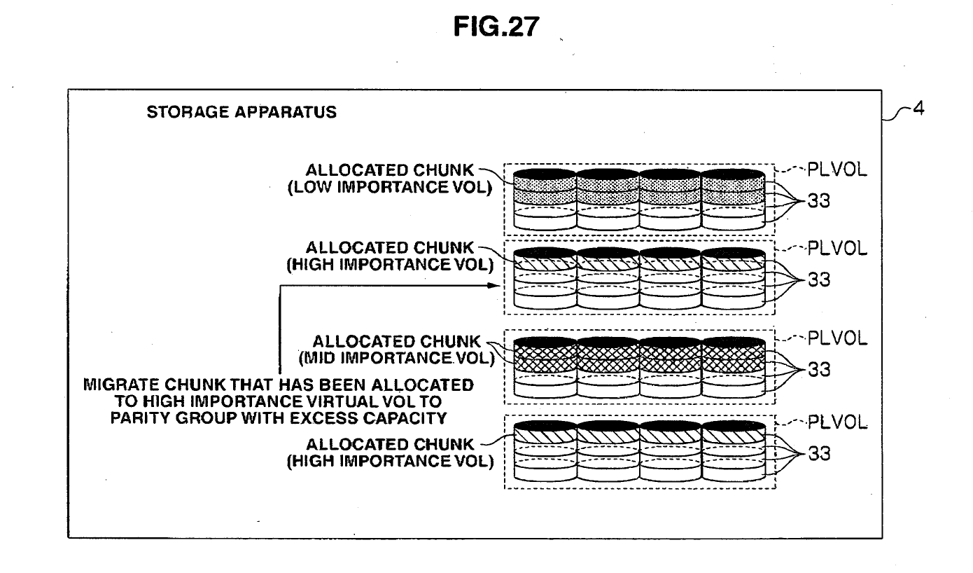

Moreover, as shown in FIG. 27 described later, if there is a “High” importance virtual volume VVOL allocated with a chunk 33 of a parity group 31 with low remaining capacity, a chunk 33 provided by the same parity group 31 with the same “Mid” quality level can be allocated to the virtual volume VVOL by reallocating the chunk 33 of the foregoing parity group 31 with a “Mid” quality level (second parity group 31 from the top in FIG. 26) with an increased remaining capacity to that virtual volume VVOL.

Thus, in this embodiment, as means for performing the foregoing processing (hereinafter referred to as the “chunk rearrangement processing”), the memory 13 of the storage apparatus 4 stores the chunk rearrangement program 47 (FIG. 4). When the controller 11 proceeds to step SP65 of the pool remaining capacity monitoring processing explained with reference to FIG. 24, it boots the chunk rearrangement program 47, and executes the foregoing chunk rearrangement processing according to the chunk rearrangement program 47.

FIG. 28 shows the specific processing contents of the controller 11 concerning the chunk rearrangement processing. When the controller 11 proceeds to step SP65 of the pool remaining capacity monitoring processing, it foremost refers to the pool management table 53 (FIG. 8), and searches for a pool volume PLVOL capable of reallocating the chunk 33 to the target “High” importance virtual volume VVOL (SP70). The target of search are the pool volumes PLVOL having a remaining capacity that is greater than the capacity of the “High” importance virtual volume VVOL and configured from a parity group 31 with a quality level of “High” or “Mid.”

When such a pool volume PLVOL exists, the controller 11 reallocates the chunk of that pool volume PLVOL to the “High” or “Mid” importance virtual volume VVOL, and migrates the data stored in the respective chunks 33 allocated to the virtual volume VVOL before the foregoing reallocation to each of the new chunks 33 after the reallocation (SP71). The controller 11 thereafter ends this chunk rearrangement processing, and returns to the pool remaining capacity monitoring processing.

Contrarily, if it was not possible to detect a pool volume PLVOL that satisfies the foregoing conditions at step SP70, the controller 11 refers to the allocated chunk management table 52 (FIG. 7) and the pool management table 53 (FIG. 8), and reallocates the chunks 33 provided by the parity group 31 with a “Low” quality level to each of the “Low” importance virtual volumes VVOL. Here, the controller 11 selects the chunk 33 to be newly allocated so that the number of parity groups 31 providing the chunks to be allocated will be smallest (SP72).

Subsequently, the controller 11 refers to the pool management table 53 and searches for a pool volume PLVOL with chunks 33 capable of reallocating a chunk 33 to the target “High” importance virtual volume VVOL (SP73). The target of search is the pool volumes PLVOL having a remaining capacity that is greater than the capacity of the “High” importance virtual volume VVOL and configured from a parity group 31 with a quality level of “High” or “Mid.”

If the controller 11 detects a pool volume PLVOL that satisfies the foregoing conditions as a result of the search, it performs the reallocation processing of the chunk 33 (SP71), thereafter ends this chunk rearrangement processing, and returns to the pool remaining capacity monitoring processing.

Contrarily, if the controller 11 was unable to detect a pool volume PLVOL that satisfied the foregoing conditions at step SP73, it displays a corresponding warning message on the management computer 5 by notifying a warning to the management computer 5 (SP74). The controller 11 thereafter ends this chunk rearrangement processing, and returns to the pool remaining capacity monitoring processing.

Incidentally, in substitute for notifying a warning to the management computer 5 at step SP74, the virtual volume migration processing explained with reference to FIG. 20 may also be executed. In such a case, the data is duplicated.

(1-44) Failed Volume Recovery Processing

The failed volume recovery processing is now explained. With the computer system 1 of this embodiment, since the data stored in the “High” importance virtual volume VVOL is duplicated and retained, even if a failure occurs in that virtual volume VVOL and becomes unrecoverable, that virtual volume VVOL can be recovered by using the duplicated data.

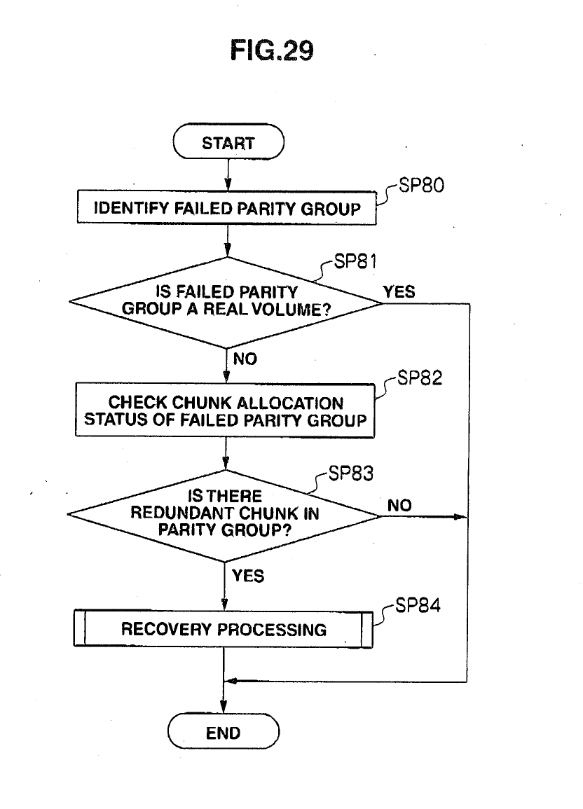

FIG. 29 shows the specific processing contents of the controller 11 upon recovering the “High” importance virtual volume VVOL that became unrecoverable due to a failure. If any volume becomes unrecoverable due to a failure, the controller 11 boots the failed volume recovery program 48 stored in the memory 13 (FIG. 4), and executes the failed volume recovery processing shown in FIG. 29 based on the failed volume recovery program 48.

Specifically, if any volume becomes unrecoverable due to a failure, the controller 11 foremost identifies the parity group (parity group subject to a failure; hereinafter referred to as the “failed parity group”) 31 providing the chunk 33 to the volume that became unrecoverable due to a failure (hereinafter referred to as the “failed volume”) based on the failure information notified to the controller 11 from the hard disk device 30 (FIG. 3) subject to a failure at the time such failure occurred (SP80).

Subsequently, the controller 11 refers to the parity group management table 54, and determines whether the attribute of the volume provided by the failed parity group 31 is a real volume RVOL (SP81). If the controller 11 obtains a positive result in the determination at step SP81, since this means that it is impossible to recover that failed volume, the controller 11 ends this failed volume recovery processing.

Contrarily, if the controller 11 obtains a negative result in the determination at step SP81, it refers to the pool management table 53 (FIG. 8), and checks the allocation status of the chunk 33 provided by the failed parity group 31 to the failed volume (SP82). Specifically, the controller 11 refers to the corresponding virtual volume allocation status column 53F of the pool management table 53, and checks whether the allocation status of each chunk 33 provided by that failed parity group 31 to the failed volume is “Allocated” or “Duplicated.”

Then, based on the findings at step SP82, the controller 11 determines whether the failed volume is a “High” importance virtual volume VVOL, and whether there is a chunk 33 storing the same data as the data stored in the chunk 33 provided by that failed parity group 31 (SP83). Specifically, the controller 11 determines whether the allocation status of each chunk 33 provided by that failed parity group 31 to the failed volume is “Duplicated.”

If the controller 11 obtains a negative result in the determination at step SP83, this means that it is impossible to recover the failed volume. Consequently, in this case, the controller 11 ends this failed volume recovery processing.

Contrarily, if the controller 11 obtains a positive result in the determination at step SP83, this means that the failed volume can be recovered using the data stored in the other chunk 33 that is not subject to a failure. Consequently, in this case, the controller 11 executes the recovery processing for recovering the failed volume (hereinafter referred to as the “high importance volume recovery processing”) (SP84), and thereafter ends this failed volume recovery processing.

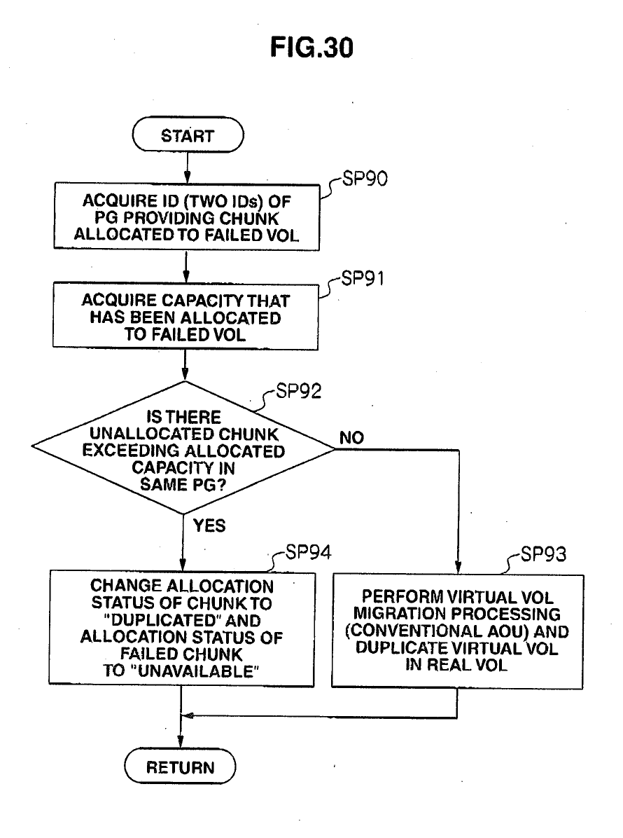

FIG. 30 shows the specific processing contents of the controller concerning the high importance volume recovery processing. When the controller 11 proceeds to step SP84 of the failed volume recovery processing, it starts the high importance volume recovery processing, foremost refers to the allocated chunk management table 52 (FIG. 7), and respectively acquires the parity group ID of the two parity groups 31 each providing two chunks 33 to the failed volume (SP90).

Subsequently, the controller 11 refers to the virtual volume management table 51 (FIG. 6), and reads the capacity of each chunk 33 allocated to the failed volume from the allocated capacity column 51E of the corresponding entry (SP91). Then, the controller 11 refers to the pool management table 53, and searches for a parity group 31 capable of providing a chunk 33 to the failed volume in substitute for the failed parity group 31 (SP92). The target of search in this case are the parity groups 31 having unallocated chunks 33 that exceed the capacity allocated to the failed volume.

If the controller 11 was unable to detect such a parity group 31, it performs the virtual volume migration processing explained with reference to FIG. 20. Here, the controller 11 duplicates the data stored in that failed volume in the real volume RVOL (SP93). The controller 11 thereafter ends this high importance volume recovery processing, and returns to the failed volume recovery processing (FIG. 29).

Contrarily, if the controller 11 was able to detect the foregoing parity group 31, it reallocates to the failed volume a chunk 33 that is unallocated to the parity group 31, and copies the data stored in the chunk 33 allocated prior to the reallocation to the reallocated chunk 33 (SP94).

Specifically, the controller 11 changes the allocation status information stored in the virtual volume allocation status column 53F of the pool management table 53 (FIG. 8) corresponding to each chunk 33 allocated to the failed volume from “Allocated” to “Unavailable” which means that it is unusable. The controller 11 also changes the allocation status information stored in each virtual volume allocation status column 53F of the pool management table 53 corresponding to each chunk 33 to be reallocated to the failed volume from “Unallocated” to “Duplicated.”

Further, the controller 1 reads the data stored in the chunk 33 before the reallocation from the backup chunk 33 storing the same data as the foregoing chunk 33, and stores this data in the chunk 33 after the reallocation.

The controller 11 thereafter ends this high importance volume recovery processing, and returns to the failed volume recovery processing.

### (1-5) Effect of Present Embodiment

As described above, with the computer system 1 according to this embodiment, since a chunk 33 provided by the same parity group 31 is allocated to a “High” or “Mid” importance virtual volume VVOL, and a chunk 33 provided by a plurality of parity groups 31 is allocated to a “Low” importance virtual volume VVOL, influence of the failure that occurred in the parity group 31 can be stochastically reduced. Consequently, it is possible to improve the maintainability of important data in the storage apparatus loaded with the AOU function.

In addition, with the computer system 1 of this embodiment, since a chunk 33 provided by a parity group 31 with a quality level of “High” or “Mid,” which does not fail easily, is allocated to a “High” or “Mid” importance virtual volume VVOL, it is possible to further improve the maintainability of important data in the storage apparatus loaded with the AOU function.

### (2) Second Embodiment

FIG. 1 shows the overall computer system 100 according to the second embodiment. This computer system 100 differs from the computer system 1 of the first embodiment in that the system administrator is also able to designate the performance and reliability to be requested to the virtual volume VOL in addition to the importance to be requested to the virtual volume VVOL.

In other words, with the computer system 100 of this embodiment, upon creating a virtual volume VVOL, the system administrator is able to designate, in addition to the importance of that virtual volume VVOL, the performance to be requested to that virtual volume VVOL (hereinafter referred to as the “virtual volume VVOL performance requirement”) and the RAID level to be requested to the parity group 3 providing the chunk 33 to that virtual volume VVOL (hereinafter referred to as the “virtual volume VVOL reliability requirement”).

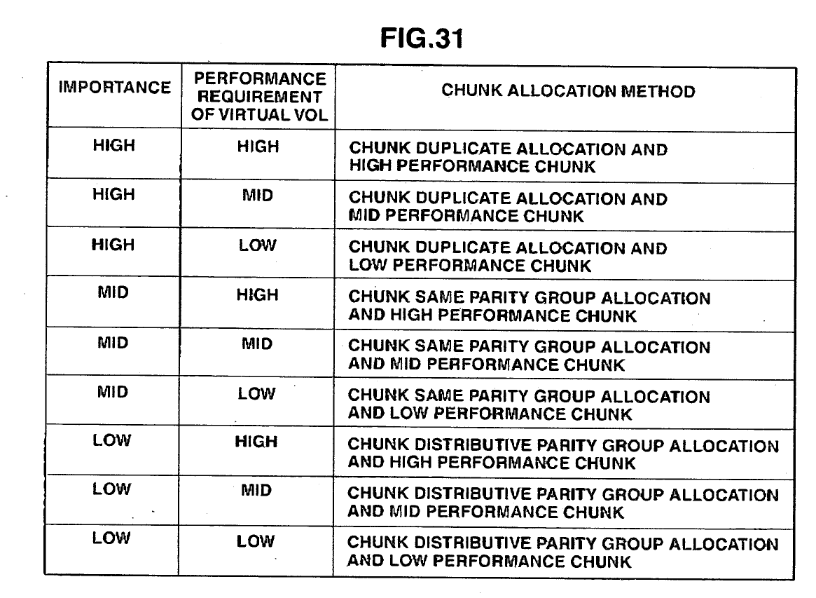

The controller 102 (FIG. 1) of the storage apparatus 101 (FIG. 1) switch the method of allocating the chunk 33 to the virtual volume VVOL as shown in FIG. 31 based particularly on the importance and virtual volume VVOL performance requirement among the importance, and the virtual volume VVOL performance requirement and reliability requirement.

Specifically, the controller 102 allocates the chunk 33 of the same parity group 31 as with the first embodiment to a “High” importance virtual volume VVOL, and further duplicates the data. The controller 11 allocates the chunk 33 of the same parity group 31 to a “Mid” importance virtual volume VVOL. Moreover, the controller 102 allocates the chunk 33 of a plurality of parity groups 31 to a “Low” importance virtual volume VVOL so that the data is distributed to a plurality of parity groups 31.

Here, as the chunk 33 to be allocated to the virtual volume VVOL, the controller 102 selects a chunk 33 of the parity group configured from high performance hard disk devices 30 (FIG. 3) if the performance to be requested to the virtual volume VVOL is “High,” selects a chunk 33 of the parity group 31 configured from mid performance hard disk devices 30 if the performance to be requested to the virtual volume VVOL is “Mid,” and selects a chunk 33 of the parity group 31 configured from low performance hard disk devices 30 if the performance to be requested to the virtual volume VVOL is “Low.”

As means for performing this kind of control, in the case of this embodiment, as shown in FIG. 4, among the various tables stored in the memory 13 of the storage apparatus 4, the configuration of the virtual volume management table 103 and the pool management table 104 differs from the first embodiment.

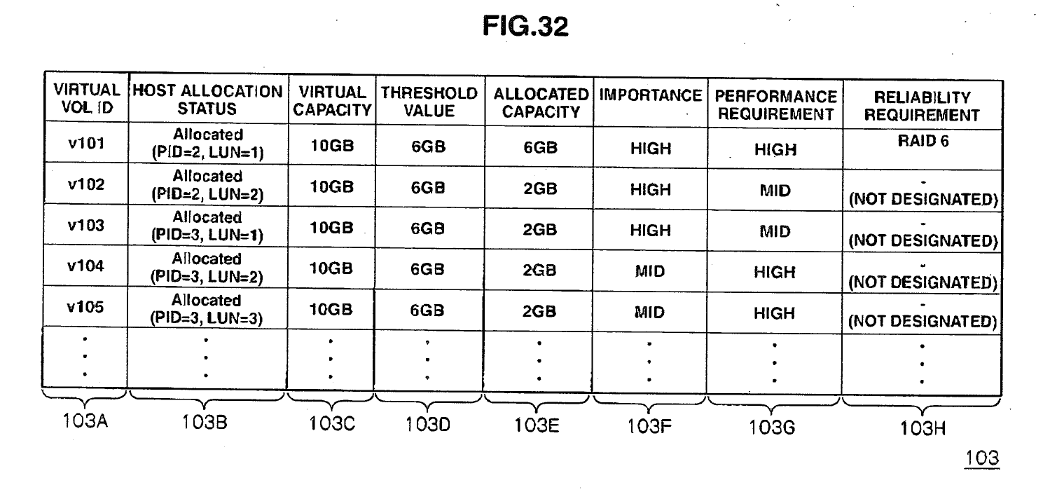

In other words, the virtual volume management table 103 according to this embodiment, as shown in FIG. 32, is configured by additionally including a performance requirement column 103G and a reliability requirement column 103H in the virtual volume management table 51 according to the first embodiment explained with reference to FIG. 6. The performance requirement column 103G stores the performance required designated by the system administrator regarding the corresponding virtual volume VVOL, and the reliability requirement column 103H stores the reliability requirement designated by the system administrator regarding the virtual volume VVOL.

Accordingly, the example of FIG. 32 shows that, with the virtual volume VVOL of “v101,” both the importance and its performance requirement are set to “High,” and “RAID 6” is set as the virtual volume VVOL reliability requirement. Moreover, the example of FIG. 32 shows that, with the virtual volume VVOL of “v102,” the importance is set to “High,” the performance requirement is set to “Mid,” and there is no designation regarding the reliability requirement.

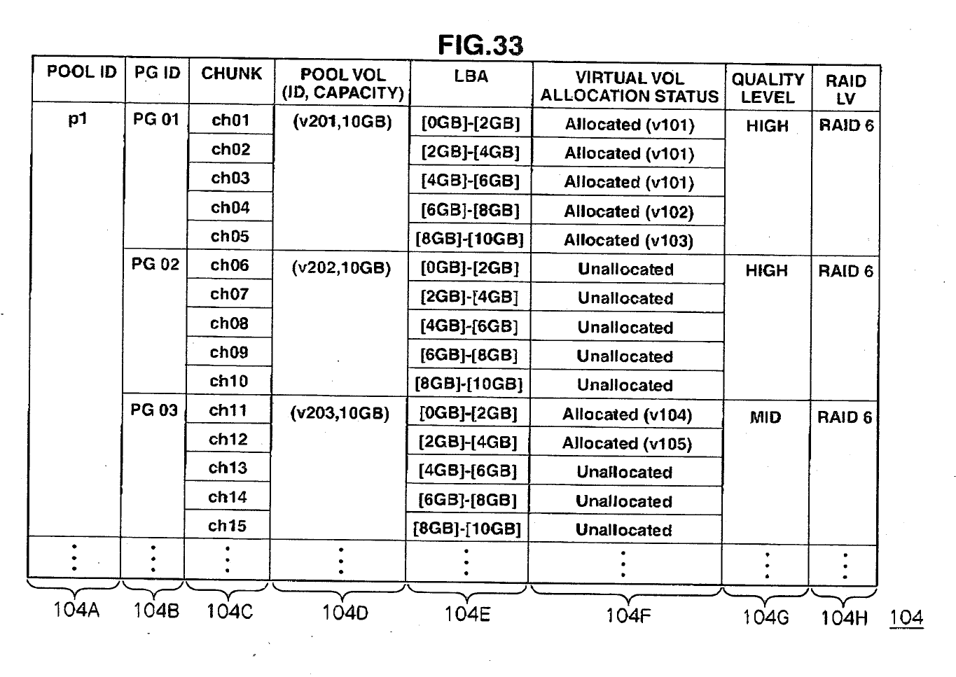

The virtual pool table 104, as shown in FIG. 33, is configured by additionally including a RAID level column 104H in the virtual pool table 53 according to the first embodiment explained with reference to FIG. 8. The RAID level column 104H stores the RAID level of the parity group 31 set by the system administrator regarding the corresponding parity group 31.

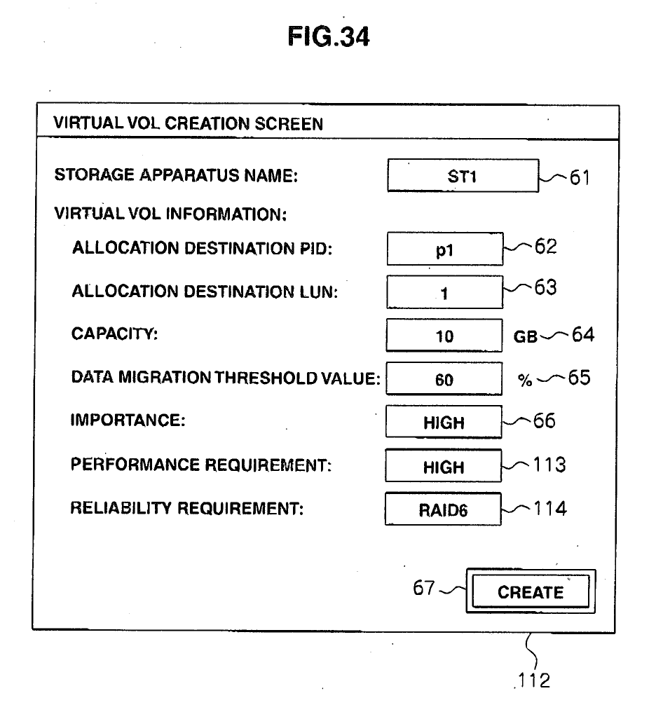

FIG. 34, which is given the same reference numerals for the portions corresponding to FIG. 10, shows the virtual volume creation screen 112 to be displayed on the management computer 10 when the management computer 110 (FIG. 1) in the computer system 100 of the second embodiment is operated and the virtual volume creation I/O program 111 (FIG. 1) loaded in the management computer 110 is booted.

The virtual volume creation screen 112 includes, in addition to the storage apparatus name input field 61, the allocation destination PID input field 62, the allocation destination LUN input field 63, the capacity input field 64, the data migration threshold value input field 65 and the importance input field 66, a performance requirement field 113 for inputting the request performance of the virtual volume VVOL to be created and a reliability requirement field 114 for inputting the virtual volume VVOL reliability requirement.

By inputting the necessary information in the storage apparatus name input field 61, the allocation destination PID input field 62, the allocation destination LUN input field 63, the capacity input field 64, the data migration threshold value input field 65, the importance input field 66, the performance requirement field 113 and the reliability requirement field 114, and thereafter clicking the Create button 67, the system administrator is able to send various types of information set on the virtual volume creation screen 112 as the virtual volume creation request from the management computer 110 to the creation destination storage apparatus 101 of the virtual volume VVOL.

The controller 102 of the storage apparatus 101 that received this virtual volume creation request creates, as in the first embodiment, the virtual volume VVOL designated by the system administrator in the storage apparatus 101 based on the various types of information contained in the virtual volume creation request. Here, the controller 102 stores the created virtual volume VVOL performance requirement and reliability requirement in the performance requirement column 103G and the reliability requirement column 104G of the virtual volume management table 103 (FIG. 32).

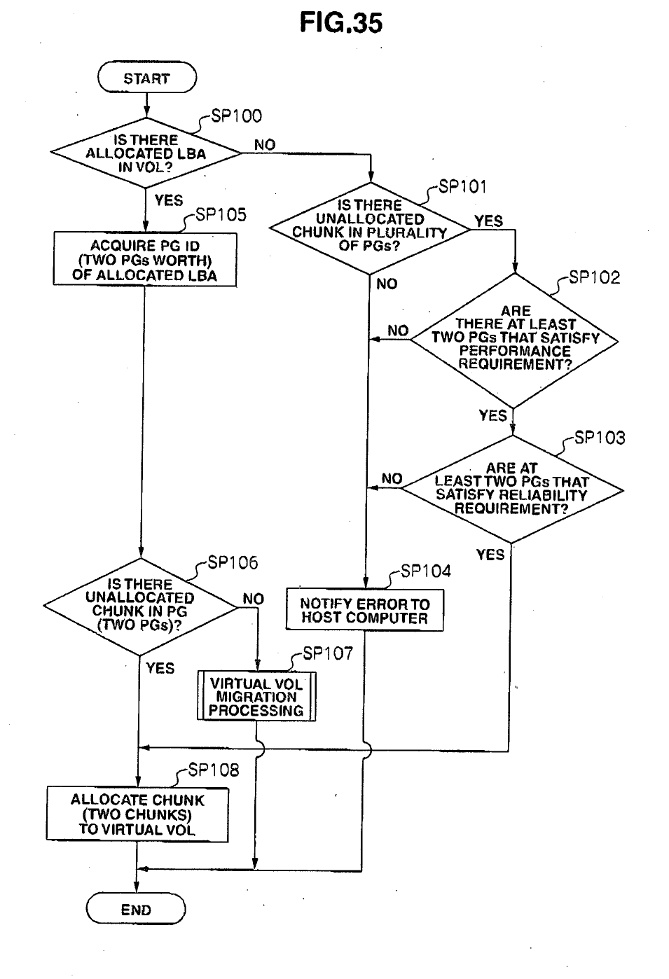

FIG. 35 shows the processing routine of the high importance volume allocation processing according to the second embodiment to be performed at step SP11 of the chunk allocation processing explained with reference to FIG. 12. The controller 102 executes the high importance volume allocation processing based on the high importance volume allocation program 120 stored in the memory 13 (FIG. 4).

In this case, the processing contents at step SP100, step SP101 and step SP104 to step SP108 of the high importance volume allocation processing are the same as step SP20 to step SP26 of the high importance volume allocation processing according to the first embodiment explained with reference to FIG. 13.

Nevertheless, with the high importance volume allocation processing of the present embodiment, if the controller 11 obtains a positive result in the determination at step SP101, it determines whether at least two parity groups 31 among the respective parity groups 31 having an unallocated chunk 33 that has not been allocated to any virtual volume VVOL satisfy the performance requirement stored in the performance requirement column 103G of the corresponding entry (entry corresponding to the virtual volume VVOL to which the chuck 33 is to be allocated) of the virtual volume management table 103 (FIG. 32) (SP102).

If the controller 102 obtains a negative result in this determination, it notifies an error to the host computer 2 (SP104). Contrarily, if the controller 102 obtains a positive result in this determination, it determines whether at least two parity groups 31 among the respective parity groups 31 satisfying the performance requirement satisfy the reliability requirement stored in the reliability requirement column 103H of the corresponding entry (entry corresponding to the virtual volume VVOL to which the chuck 33 is to be allocated) of the virtual volume management table 103 (SP103).

If the controller 102 obtains a negative result in this determination, it notifies an error to the host computer 2 (SP104). Contrarily, if the controller 102 obtains a positive result in this determination, it allocates, one by one, the unallocated chunks 33 provided respectively by the two parity groups 31 satisfying the performance requirement and the reliability requirement to the data block 34 (FIG. 3) designated in the access request in the virtual volume VVOL designated in the access request (SP108).

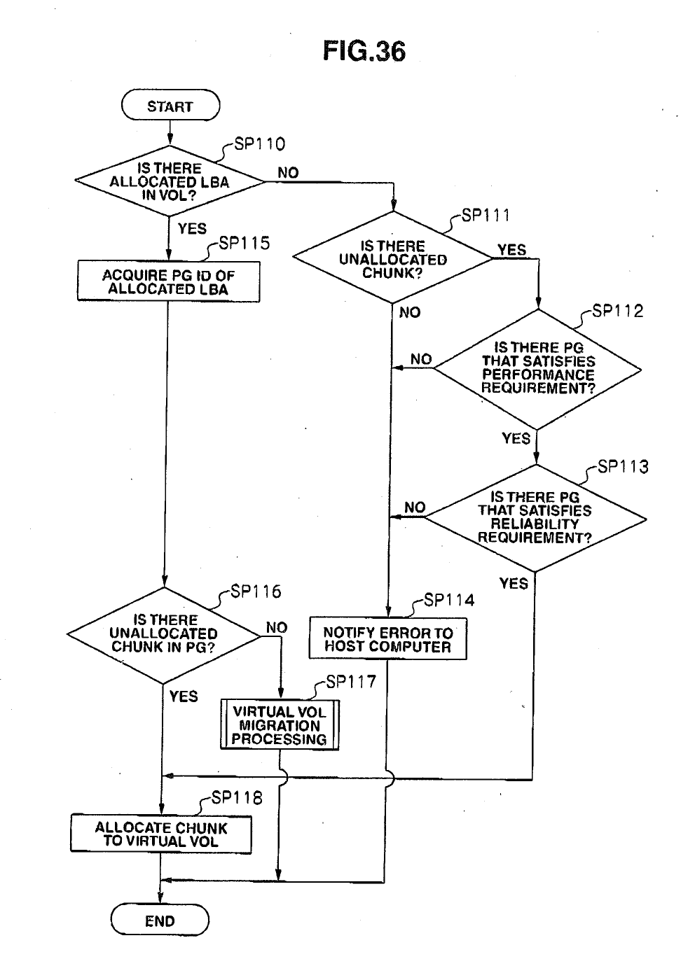

Meanwhile, FIG. 36 shows the processing routine of the mid importance volume allocation processing according to the second embodiment to be performed at step SP12 of the chunk allocation processing explained with reference to FIG. 12. The controller 102 executes the mid importance volume allocation processing based on the mid importance volume allocation program 121 stores in the memory 13 (FIG. 4).

In this case, step SP110, step SP111 and step SP114 to step SP118 of the mid importance volume allocation processing are the same as step SP40 to step SP46 of the mid importance volume allocation processing according to the first embodiment explained with reference to FIG. 21.

Nevertheless, with the mid importance volume allocation processing of the present embodiment, if the controller 102 obtains a positive result in the determination at step SP111, it determines whether a parity group 31 having an unallocated chunk 33 that has not been allocated to any virtual volume VVOL satisfies the performance requirement stored in the performance requirement column 103G of the corresponding entry (entry corresponding to the virtual volume VVOL to which the chuck 33 is to be allocated) of the virtual volume management table 103 (FIG. 32) (SP112).

If the controller 102 obtains a negative result in this determination, it notifies an error to the host computer 2 (SP114). Contrarily, if the controller 102 obtains a positive result in this determination, it determines whether a parity group 31 satisfying the performance requirement satisfies the reliability requirement stored in the reliability requirement column 103H of the corresponding entry (entry corresponding to the virtual volume VVOL to which the chuck 33 is to be allocated) of the virtual volume management table 103 (SP113).

If the controller 102 obtains a negative result in this determination, it notifies an error to the host computer 2 (SP114). Contrarily, if the controller 102 obtains a positive result in this determination, it allocates the unallocated chunk 33 provided by the parity group 31 satisfying the performance requirement and the reliability requirement to that virtual volume VVOL (SP118).

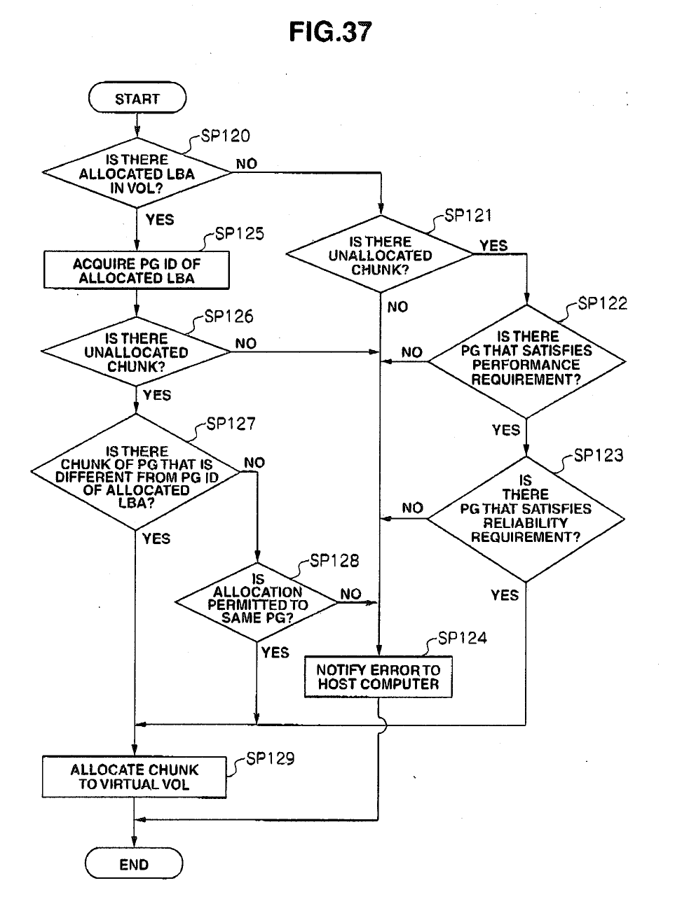

Meanwhile, FIG. 37 shows the processing routine of the low importance volume allocation processing according to the second embodiment to be performed at step SP13 of the chunk allocation processing explained with reference to FIG. 12. The controller 102 executes the low importance volume allocation processing according to the low importance volume allocation program 122 (FIG. 4) stored in the memory 13 (FIG. 4).

In this case, step SP120, step SP121 and step SP124 to step SP129 of the low importance volume allocation processing are the same as step SP50 to step SP57 of the low importance volume allocation processing according to the first embodiment explained with reference to FIG. 22.

Nevertheless, with the low importance volume allocation processing of the present embodiment, if the controller 102 obtains a positive result in the determination at step SP121, it determines whether a parity group 31 having an unallocated chunk 33 that has not been allocated to any virtual volume VVOL satisfies the performance requirement stored in the performance requirement column 103G of the corresponding entry (entry corresponding to the virtual volume VVOL to which the chuck 33 is to be allocated) of the virtual volume management table 103 (FIG. 32) (SP122).

If the controller 102 obtains a negative result in this determination, it notifies an error to the host computer 2 (SP124). Contrarily, if the controller 102 obtains a positive result in this determination, it determines whether a parity group 31 satisfying the performance requirement satisfies the reliability requirement stored in the reliability requirement column 103H of the corresponding entry (entry corresponding to the virtual volume VVOL to which the chuck 33 is to be allocated) of the virtual volume management table 103 (SP133).

If the controller 102 obtains a negative result in this determination, it notifies an error to the host computer 2 (SP124). Contrarily, if the controller 102 obtains a positive result in this determination, it allocates the unallocated chunk 33 provided by the parity group 31 satisfying the performance requirement and the reliability requirement to that virtual volume VVOL (SP129),

According to the foregoing processing, the controller 102 is able to allocate a chunk 33 that satisfies the performance requirement and the reliability requirement designated by the system administrator to the virtual volume VVOL.

As described above, with the computer system 100 of the present embodiment, since it is also possible to designate the performance and reliability of to be requested to the virtual volume VVOL, in addition to the effect yielded in the first embodiment, it is possible to provide an AOU function capable of configuring a more detailed setting according to the users' needs, and consequently possible to further improve the usability of the computer system 100.

### (3) Third Embodiment

FIG. 1 shows the overall computer system 200 according to the third embodiment. The computer system 200 is configured the same as the computer system 1 according to the first embodiment other than that, at the stage of creating a “High” or “Mid” importance virtual volume VVOL, the controller 202 of the storage apparatus 201 allocates the chunks 33 in advance to the respective data blocks 34 (FIG. 3) of the virtual volume VVOL.

Specifically, with the computer system 200 according to this embodiment, when a creation request of a “High” or Mid” importance virtual volume VVOL is sent from the management computer 5 to the storage apparatus 201, the controller 202 of the storage apparatus 201 previously stores chunks 33 in the same capacity as the capacity of the virtual volume VVOL from the two parity groups 31 both having a remaining capacity that is greater than the capacity of that virtual volume VVOL.

The controller 202 associates each of the secured chunks 33 in advance with each of the data blocks 34 of the virtual volume VVOL, and thereafter allocates the associated chunk 33 to the virtual volume VVOL when a write request to the virtual volume VVOL is issued from the host computer 2.

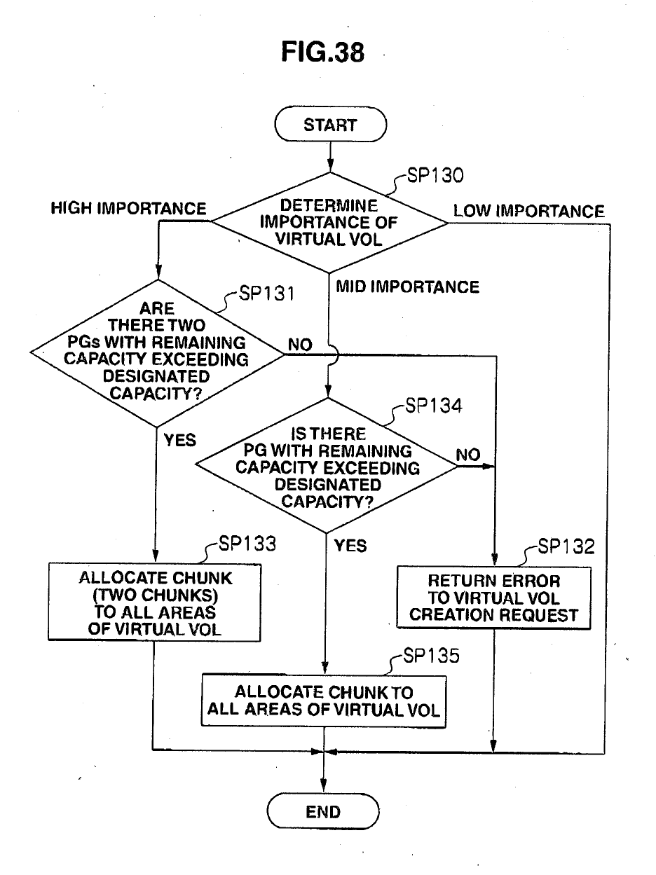

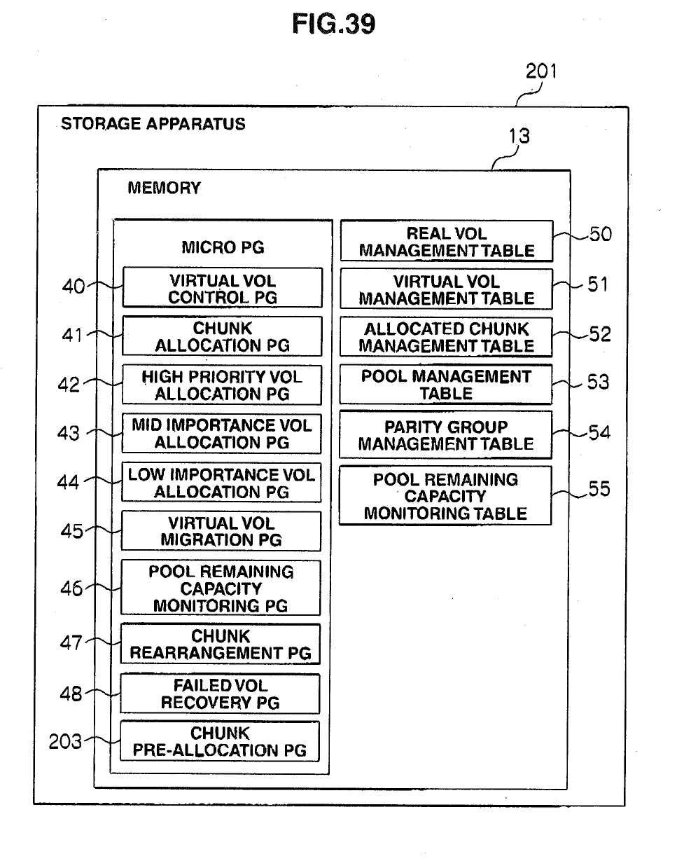

FIG. 38 shows the processing routine of the chunk pre-allocation processing to be executed by the controller 202 of the storage apparatus 201 immediately after the creation of the designated according to the volume creation request from the management computer 5 in the computer system 200 according to the third embodiment. The controller 202 executes the chunk pre-allocation processing shown in FIG. 38 based on the chunk pre-allocation program 203 stored in the memory 13 as shown in FIG. 39.

Specifically, when the controller 202 creates the requested virtual volume VVOL according to the volume creation request from the management computer 5, it starts the chunk pre-allocation processing, and foremost determines the importance of the created virtual volume VVOL based on the volume creation request of the virtual volume VVOL received previously from the management computer 5 (SP130).

If the importance of the virtual volume VVOL is “High,” the controller 202 determines whether there are at least two parity groups 31 with a quality level of “High” and which have a remaining capacity that is greater than the capacity of the created virtual volume VVOL (SP131).

If the controller 202 obtains a negative result in this determination, it sends an error notice to the management computer 5 in response to the volume creation request of the created virtual volume VVOL (SP132). Consequently, in accordance with the error notice, the management computer 5 displays a warning such as “A virtual volume in the designated capacity and importance cannot be created.” In substitute for the warning, the controller 202 may display a message such as “A virtual volume can be created if it can be distributed to a separate parity group as a low importance virtual volume” on the management computer 5. The controller 202 thereafter ends this chunk pre-allocation processing.

Contrarily, if the controller 202 obtains a positive result in the determination at step SP131, it allocates the chunks 33 of two different parity groups 31 (one chunk per parity group 31) to all data blocks 34 of the created virtual volume NOL (SP133). The controller 202 thereafter ends this chunk pre-allocation processing.

Meanwhile, if the importance of the created virtual volume VVOL is “Mid,” the controller 202 determines whether there is a parity group with a quality level of “High” or “Mid” and with a remaining capacity that is greater than the capacity of the created virtual volume VVOL (SP134).

If the controller 202 obtains a negative result in this determination, it proceeds to step SP132. Contrarily, if the controller 202 obtains a positive result in this determination, it allocates the chunks 33 of the parity groups 31 (one chunk at a time) detected at step SP134 to all data blocks 34 of the created virtual volume VVOL (SP135). The controller 202 thereafter ends this chunk pre-allocation processing.

Accordingly, with the computer system 200 of this embodiment, since chunks 33 are allocated to the respective data blocks 34 (FIG. 3) of the virtual volume VVOL in advance at the stage of creating a “High” or “Mid” importance virtual volume VVOL, the controller 202 does not have to perform complicated processing such as the foregoing pool remaining capacity monitoring processing, and the load of the controller 202 can thereby be reduced. Accordingly, it is possible to effectively prevent the performance deterioration in the data I/O processing in storage apparatuses with low performance caused by the pool remaining capacity monitoring processing.

### (4) Other Embodiments

Although the first to third embodiments described above explained cases of applying the present invention to the computer systems 1, 100, 200 configured as shown in FIG. 1, the present invention is not limited to the foregoing configuration, and may be broadly applied to computer systems of various other configurations.

Moreover, although the first to third embodiments explained a case of setting the importance of the virtual volume VVOL to the three levels of “High,” “Mid” and “Low,” the present invention is not limited to the foregoing configuration, and the importance may be set to two levels or four levels or more.

Similarly, although the first to third embodiments described a case of setting the quality level of the parity group to the three levels of “High,” “Mid” and “Low,” the present invention is not limited to the foregoing configuration, and the quality level may be set to two levels or four levels or more.

In addition, although the foregoing embodiments described a case of configuring the management unit for managing the importance set to each of the virtual volumes with the controllers 11, 102, 202 of the storage apparatus 4 and the virtual volume control program 40, configuring the storage area allocation unit for dynamically allocating a storage area (chunk 33) to the virtual volume VVOL with the controllers 11, 102, 202 and the chunk allocation program 41, the high importance volume allocation programs 42, 120, the mid importance volume allocation programs 43, 121 and the low importance volume allocation programs 43, 122, and configuring the control unit for controlling the reading and writing of data from the host apparatus (host computer 2) from and into the storage area (chunk 33) allocated to the virtual volume VVOL from the controllers 11, 102, 202, the present invention is not limited to the foregoing configuration, and various other configurations may be broadly applied to the configuration of the management unit, the storage area allocation unit and the control unit.

The present invention can be broadly applied to storage apparatuses loaded with the AOU function.

What is claimed is:

1. A storage apparatus for presenting a plurality of virtual volumes to a host apparatus, and dynamically allocating to each of the plurality of virtual volumes a physical storage area for storing data according to the usage status of each of the plurality of virtual volumes, comprising:
a management unit for managing the importance set to each of the plurality of virtual volumes; and
a storage area allocation unit for dynamically allocating a storage area to each of the plurality of virtual volumes;
wherein the storage area allocation unit allocates, based on the importance, a storage area provided by a plurality of memory apparatus groups respectively configured from a plurality of memory apparatuses to one or more virtual volumes with low importance among the plurality of virtual volumes, and allocates a storage area provided by one of the memory apparatus groups to other virtual volumes among the plurality of virtual volumes.

2. The storage apparatus according to claim 1,
wherein the memory apparatus group is a parity group operated in RAID (Redundant Array of Inexpensive Disks) format configured from the plurality of memory apparatuses.

3. The storage apparatus according to claim 1, further comprising;
a control unit for controlling the reading and writing of data from the host apparatus from and into the storage area allocated to each of the plurality of virtual volumes;
wherein the storage area allocation unit respectively allocates a storage area provided by one of the memory apparatus groups and a storage area provided by one other memory apparatus group that is different from the parity group to one or more virtual volumes with high importance among the plurality of virtual volumes; and
wherein the control unit writes data from the host apparatus in both of the storage areas allocated to the one or more virtual volumes with high importance among the plurality of virtual volumes.

4. The storage apparatus according 3,
wherein the storage area allocation unit allocates a storage area provided by one of the memory apparatus groups to one or more virtual volumes with mid importance among the plurality of virtual volumes.

5. The storage apparatus according to claim 1,
wherein the management unit manages the quality level of the storage area; and
wherein the storage area allocation unit allocates the storage area with a relatively high quality level to one or more virtual volumes with relatively high importance among the plurality of virtual volumes, and allocates the storage area with a relatively low quality level to one or more virtual volumes with relatively low importance among the plurality of virtual volumes.

6. A control method of a storage apparatus for presenting a plurality of virtual volumes to a host apparatus, and dynamically allocating to each of the plurality of virtual volumes a physical storage area for storing data according to the usage status of each of the plurality of virtual volumes, comprising:
a first step of managing the importance set to each of the plurality of virtual volumes; and
a second step of dynamically allocating a storage area to each of the plurality of virtual volumes;
wherein, at the second step, based on the importance, a storage area provided by a plurality of memory apparatus groups respectively configured from a plurality of memory apparatuses is allocated to one or more virtual volumes with low importance among the plurality of virtual volumes, and a storage area provided by one of the memory apparatus groups is allocated to other virtual volumes among the plurality of virtual volumes.

7. The control method of a storage apparatus according to claim 6,
wherein the memory apparatus group is a parity group operated in RAID (Redundant Array of Inexpensive Disks) format configured from the plurality of memory apparatuses.

8. The control method of a storage apparatus according to claim 6, further comprising:
a third step of controlling the reading and writing of data from the host apparatus from and into the storage area allocated to each of the plurality of virtual volumes;
wherein, at the second step, a storage area provided by one of the memory apparatus groups and a storage area provided by one other memory apparatus group that is different from the parity group are respectively allocated to one or more virtual volumes with high importance among the plurality of virtual volumes; and
wherein, at the third step, data from the host apparatus is written in both of the storage areas allocated to the one or more virtual volumes with high importance among the plurality of virtual volumes.

9. The control method of a storage apparatus according to claim 8,
wherein, at the second step, a storage area provided by one of the memory apparatus groups is allocated to one or more virtual volumes with mid importance among the plurality of virtual volumes.

10. The control method of a storage apparatus according to claim 6,
wherein, at the first step, the quality level of the storage area is managed; and
wherein, at the second step, the storage area with a relatively high quality level is allocated to one or more virtual volumes with relatively high importance among the plurality of virtual volumes, and the storage area with a relatively low quality level is allocated to one or more virtual volumes with relatively low importance among the plurality of virtual volumes.
